(19) United States
(12) Patent Application Publication
(10) Pub. No.: US 2026/0057564 A1
(43) Pub. Date: Feb. 26, 2026

(54) Location Search Based on Model-Generated Synthetic Images

(71) Applicant: Google LLC, Mountain View, CA (US)

(72) Inventor: Arash Sadr, Belmont, CA (US)

(21) Appl. No.: 18/813,923

(22) Filed: Aug. 23, 2024

(51) Int. Cl. G06T 11/00; G06F 16/29; G06T 3/4038; G06V 10/44; G06V 10/764

(52) U.S. Cl. CPC G06T 11/00; G06F 16/29; G06T 3/4038; G06V 10/44; G06V 10/764

(57) ABSTRACT

Systems and methods for searching using machine-learned model-generated outputs can provide a user with a medium for generating synthetic images depicting synthetic environments that can then be matched to a real world example. The systems and methods can include obtaining a search query, which can be utilized to generate a prompt input that can be processed by an image generation model to generate a plurality of model-generated images. A selection can then be received that selects a particular model-generated image to utilize to query a database.

### FIELD

The present disclosure relates generally to machine-learned model output-leveraged search. More particularly, the present disclosure relates to obtaining user interface inputs to generate a prompt input that can be processed by a machine-learned model to generate outputs that can be reviewed by a user and selected to be input into a search engine to receive search results associated with the selected output.

### BACKGROUND

Searching for clothing, art, movies, and/or music can be difficult if a user does not have an example to provide to a search engine. Freeform text and/or Boolean strings provided as a text query to a search engine may provide mixed and/or unaligned search results that may be off topic and/or may include only parts of the search query. Refining those searches and/or reviewing those search results can be time intensive and may be non-intuitive. Image queries may provide more tailored results as images may include features that cannot be descriptively described via text in brevity. However, a user may not have access to an image of what they are looking for during the search, and/or the user may be basing their search on a real world example that they know of based on real world experience (e.g., a user may searching for a real world example of what they imagined).

The content being requested by the user may not be readily available to the user based on the user not knowing where to search, based on the storage location of the content, and/or based on the content not existing. The user may be requesting search results based on an imagined concept without a clear way to express the imagined concept.

Additionally, the utilization of artificial intelligence techniques to generate images and/or other datasets can be non-intuitive, may be open-ended, and may be time consuming. Current image generation systems utilize a prompt input box for receiving freeform text to be processed to generate one or more images. However, as a user utilizes the prompt input box, the user may struggle with which words to utilize and/or may be dissatisfied with the generated image as one or more of the input words may not be utilized in the direction the user desired (e.g., “houndstooth” may be entered by the user in association with the pattern; however, the model may generate an image with a dog's teeth).

### SUMMARY

Aspects and advantages of embodiments of the present disclosure will be set forth in part in the following description, or can be learned from the description, or can be learned through practice of the embodiments.

One example aspect of the present disclosure is directed to a computing system for location searching. The system can include one or more processors and one or more non-transitory computer-readable media that collectively store instructions that, when executed by the one or more processors, cause the computing system to perform operations. The operations can include obtaining a search query. The search query can include a plurality of search terms. The plurality of search terms can include a plurality of different environment descriptors. The operations can include processing the search query with an image generation model to generate one or more model-generated images. The one or more model-generated images can include a plurality of predicted pixels descriptive of a predicted rendering of a model-generated environment comprising each of the plurality of different environment descriptors. The image generation model can include a generative model trained for text-to-image generation. The operations can include processing the one or more model-generated images with a search engine to determine one or more location search results based on image features of the one or more model-generated images. The one or more location search results can be associated with one or more model-generated environment features depicted in the one or more model-generated images. The operations can include providing the one or more location search results for display with geographic information for the one or more location search results.

In some implementations, the one or more model-generated images can include one or more three-hundred and sixty degree renderings of the model-generated environment comprising each of the plurality of different environment descriptors. The operations can include providing an interactive user interface for providing an interactive window for viewing different portions of the one or more three-hundred and sixty degree renderings of the model-generated environment including each of the plurality of different environment descriptors. Processing the one or more model-generated images with the search engine to determine the one or more location search results based on the image features of the one or more model-generated images can include determining a sub-portion of the one or more three-hundred and sixty degree renderings of the model-generated environment is being viewed when a search invoking element is selected, segmenting the sub-portion of the one or more three-hundred and sixty degree renderings of the model-generated environment, and providing the sub-portion of the one or more three-hundred and sixty degree renderings of the model-generated environment to the search engine to determine the one or more location search results. The plurality of different environment descriptors can be descriptive of features found in particular real world locations. The plurality of different environment descriptors can be descriptive of particular types of geographic features, particular architecture, particular flora, particular fauna, particular object combinations, and/or other features that are found in particular settings.

In some implementations, processing the search query with the image generation model to generate the one or more model-generated images can include generating a plurality of different candidate model-generated images based on processing the search query with the image generation model, evaluating the plurality of different candidate model-generated images to generate a plurality of respective image scores, and determining the one or more model-generated images of the plurality of different candidate model-generated images to provide to the search engine based on the plurality of respective image scores. The plurality of respective image scores can be determined based on: processing each of the plurality of different candidate model-generated images with one or more classification models to determine whether a respective candidate model-generated image comprises each of the plurality of different environment descriptors. The plurality of respective image scores can be determined based on: evaluating each of the plurality of different candidate model-generated images on one or more benchmarks for realism and hallucinations.

In some implementations, processing the search query with the image generation model to generate the one or more model-generated images can include generating a plurality of different initial model-generated images based on processing the search query with the image generation model, and mosaicking the plurality of different initial model-generated images to generate the one or more model-generated images. The operations can include obtaining a task graph associated with a particular user that provided the search query. The task graph can include a learned embedding representation associated with learned interests of the user. Processing the search query with the image generation model to generate the one or more model-generated images can include processing the search query and the task graph with the image generation model to generate the one or more model-generated images. In some implementations, the task graph may be learned based on learning edges and nodes associated with the learned embedding representation by: embedding search history instances of the particular user to generate a plurality of nodes and determining a plurality of edges by determining interlinking groupings between the plurality of nodes.

Another example aspect of the present disclosure is directed to a computer-implemented method for searching with synthetic images. The method can include obtaining, by a computing system including one or more processors, a prompt input. The prompt input can include a plurality of terms. The plurality of terms can include a description of a plurality of different environmental characteristics. The method can include processing, by the computing system, the prompt input with an image generation model to generate one or more model-generated images. The one or more model-generated images can be generated based at least in part on the plurality of terms. The image generation model may have been trained to process text data to generate one or more images comprising predicted pixels associated with features described with the text data. The text data can be descriptive of a plurality of different environment features. The method can include determining, by the computing system, one or more location search results based on the one or more model-generated images. The one or more location search results can be associated with one or more model-generated environment features depicted in the one or more model-generated images. The method can include providing, by the computing system, a search results interface. The search results interface can provide the one or more location search results for display with geographic information for the one or more location search results.

In some implementations, the plurality of terms can describe a particular type of terrain and a particular type of plant. The one or more model-generated images may depict a rendering of the particular type of plant within the particular type of terrain. In some implementations, the plurality of terms may describe a particular type of architecture and a particular type of climate. The one or more model-generated images may depict a rendering of the particular type of architecture within the particular type of climate. In some implementations, the plurality of terms may describe a first attraction type and a second attraction type. The one or more model-generated images may depict a rendering of a model-generated environment that includes the first attraction type and the second attraction type.

In some implementations, the method can include obtaining, by the computing system, location data associated with a user location; determining, by the computing system, one or more travel options for traveling from the user location to one or more destination locations associated with the one or more location search results; and providing, by the computing system, the one or more travel options for display.

In some implementations, the method may include, for each of the one or more location search results, determining, by the computing system, a plurality of attractions associated with a respective location associated with a respective location search result; generating a respective itinerary for the respective location search result, wherein the respective itinerary comprises a schedule for attending at least a subset of the plurality of attractions; and providing the respective itinerary for display within the search results interface.

Another example aspect of the present disclosure is directed to one or more non-transitory computer-readable media that collectively store instructions that, when executed by one or more computing devices, cause the one or more computing devices to perform operations. The operations can include obtaining a prompt input from a user computing device. The prompt input can include a plurality of terms. The plurality of terms can include a description of a plurality of different food items. The operations can include determining a user location of a particular user associated with the user computing device and processing the prompt input with an image generation model to generate one or more model-generated images. The one or more model-generated images can be generated based at least in part on the plurality of terms. The image generation model may have been trained to process text data to generate one or more images including predicted pixels associated with food characteristics described with the text data. The text data can be descriptive of a plurality of different features. The operations can include processing the one or more model-generated images and the user location with a search engine to determine one or more restaurant search results. The one or more restaurant search results can be associated with a plurality of model-generated food items depicted in the one or more model-generated images. The one or more restaurant search results can be within a threshold distance from the user location. The operations can include providing a search results interface. The search results interface can provide the one or more search results for display with geographic information for the one or more search results.

In some implementations, the plurality of terms may include an aesthetic description. The one or more model-generated images may include a rendering of the plurality of model-generated food items within a model-generated environment that comprises the aesthetic description. In some implementations, the one or more model-generated images may depict a first food item of a first food type and a second food item of a second food type. The one or more model-generated images may include a rendering of a model-generated menu that includes the plurality of model-generated food items.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example model-generated image search system according to example embodiments of the present disclosure.

FIG. 2 depicts a block diagram of an example model-generated image search and customization system according to example embodiments of the present disclosure.

FIG. 3 depicts a flow chart diagram of an example method to perform location search result determination according to example embodiments of the present disclosure.

FIG. 4 depicts a block diagram of an example model-generated image search system according to example embodiments of the present disclosure.

FIG. 5 depicts a block diagram of an example machine-learned model processing and search system according to example embodiments of the present disclosure.

FIG. 6 depicts a block diagram of an example generative artificial intelligence-leveraged search system according to example embodiments of the present disclosure.

FIG. 7 depicts a flow chart diagram of an example method to perform synthetic image-based search according to example embodiments of the present disclosure.

FIG. 8 depicts a flow chart diagram of an example method to perform restaurant search according to example embodiments of the present disclosure.

FIG. 9A-9M depict illustrations of an example search interface according to example embodiments of the present disclosure.

FIG. 10A-10B depict illustrations of example prompt-image pairs according to example embodiments of the present disclosure.

FIG. 11 depicts a flow chart diagram of an example method to perform image generation and search according to example embodiments of the present disclosure.

FIG. 12 depicts an illustration of an example collections interface according to example embodiments of the present disclosure.

FIG. 13A-13E depict illustrations of example search interface entry points according to example embodiments of the present disclosure.

FIG. 14 depicts an illustration of an example collections interface according to example embodiments of the present disclosure.

FIG. 15 depicts illustrations of example suggestion interfaces according to example embodiments of the present disclosure.

FIG. 16 depicts a flow chart diagram of an example method to perform machine-learned model output generation and search according to example embodiments of the present disclosure.

FIG. 17 depicts a flow chart diagram of an example method to perform prompt input generation according to example embodiments of the present disclosure.

FIG. 18A depicts a block diagram of an example computing system that performs machine-learned model output generation and search according to example embodiments of the present disclosure.

FIG. 18B depicts a block diagram of an example computing system that performs machine-learned model output generation and search according to example embodiments of the present disclosure.

Reference numerals that are repeated across plural figures are intended to identify the same features in various implementations.

### DETAILED DESCRIPTION

Generally, the present disclosure is directed to generating synthetic images based on a user request (e.g., a search query) to provide a visualization of a requested environment that can then be searched to provide a visually informed and directed location search. The systems and methods disclosed herein can leverage one or more image generation models (e.g., a text-to-image diffusion model) to generate synthetic images that can then be utilized for querying a search engine to obtain location search results. For example, a user may have an idea or concept that the user desires to find one or more real world examples of the idea or concept (e.g., a user may be searching for a city that has a particular type of road but also has a particular type of architecture). Therefore, a user may generate a search query (and/or a prompt input) that can be provided to an image generation model to generate one or more synthetic images. A user may then select a particular candidate synthetic image that can then be utilized to search one or more databases to obtain location search results. For example, the image generation model may generate a plurality of candidate synthetic images in response to the search query. The plurality of model-generated images can be provided to a user interface, which can include a displayed list, a carousel, and/or one or more other presentation methods. A user can then review the plurality of model-generated images to determine one or more particular model-generated images that may be utilized for searching one or more databases. The one or more particular model-generated datasets can be utilized for querying one or more databases to obtain one or more location search results.

Generating and searching model-generated renderings of environments based on input search queries can provide a more detailed and immersive medium for searching for travel destinations and/or other attractions. In particular, a search query can be processed with an image generation model to render a model-generated image of an imagined environment, which can then be searched to provide for a user's imagined destination to be rendered, viewed, and searched to determine a real world location that matches the model-generated environment. The image generation and search can be provided within a web search interface, a map application interface, an image generation interface, and/or other user interface. Traveling, activities, and restaurants may be suggested based on the synthetic image generation. The synthetic image generation may be performed and/or condition based on learned user preferences, which may include learning an embedding-based task graph associated with a user, which can then be leveraged for tuning and/or conditioning the image generation model.

Finding travel destinations based on purely search terms can provide a mix of relevant results, partially relevant results, and/or spam. Travel websites can use hot button terms to attract searchers to their web pages without meeting a desired criterion. Alternatively and/or additionally, the search results may be only responsive to a subset of the search query. Moreover, existing travel planning tools can be restrictive, relying on existing destinations and pre-defined search criteria, making planning difficult for users to express their ideal travel experience in traditional search terms. The results can be a significant gap between imagination and reality in the travel planning process.

An image generation model, reverse image search techniques, and personalized task graphs can be leveraged to obtain search results that are responsive to an environment envisioned by the user. An image generation model can be leveraged to render an environment described by a text query. The model-generated images can then be provided to the user, which can allow the user to select a particular image to search. Image feature recognition can then be leveraged to determine search results that include locations that have the characteristics requested by the user. Additionally and/or alternatively, user task graphs can be leveraged for image generation conditioning and/or search result filtering.

In some implementations, the systems and methods disclosed herein can enable users to discover their perfect destinations whatever they may be, by unleashing the power of their imagination. Through a combination of generative artificial intelligence (AI), image diffusion, and/or visual search, users can render and explore their dream destinations, unconstrained by existing locations. The systems and methods can be leveraged for a variety of tasks ranging from a restaurant near the user to an island on the other side of the earth.

The image generation and search can reduce the quantity of queries input and processed for each search instance while also reducing the transmission of content that is not requested (e.g., spam), which can save on the computational cost of search. Additionally, a search engine interface feature and/or a standalone application for generative AI-led travel destination search can provide for an immersive interface for users to envision a vacation then make their dream vacation come to life as the imagined destination is identified based on searching a rendered model-generated image. Users can find their dream destination without reliance on word of mouth, travel agencies, long tail queries, and/or iterative search instances.

The systems and methods can obtain text data, image data, audio data, multimodal data, latent encoding data, and/or other data. The obtained data can then be processed to generate one or more model-generated images that can then be searched. The user interface may include an upload interface, an image combination tool, an interactive exploration interface (e.g., for viewing three-hundred and sixty degree renderings), information displays, user profile obtainment/tracking/management, and/or other interface features.

In some implementations, the systems and methods can include an image generation model, a location search model, and/or personalization model. The image generation model may be configured, tuned, and/or trained to process a search query (and/or prompt input) to generate one or more model-generated images. The image generation model may include a natural language processing model and/or natural language processing training, which may include a text encoder. The image generation model may include an image understanding model and/or may be trained for image processing for image uploads, which may include an image encoder. In some implementations, the image generation model may include a speech-to-text model for voice input processing. The image generation model may include one or more image diffusion models for generating the synthetic images (e.g., an AI image diffusion model that translates user inputs into detailed visual representations). In some implementations the image generation model may be configured, tuned, and/or trained to process text prompts, image uploads, voice descriptions, and/or any combination of inputs. The image generation model can include and/or communicate one or more application programming interfaces (APIs), which may include a visual search application programming interface for visual searches for real-world destinations that closely match the generated image.

The location search model may include an image embedding model, a search engine, and/or a classification model. In some implementations, the location search model may perform computer vision for visual search and/or machine-learning techniques for matching and/or ranking destinations. The location search model may include and/or communicate one or more application programming interfaces (APIs), which may include a visual search application programming interface for visual searches for real-world destinations that closely match the generated image. Additionally and/or alternatively, the location search model may consider multiple factors (e.g., terrain, colors, architecture, activities, etc.) to find the best fit. In some implementations, the location search model may include refinement options that allow a user to tweak prompts or images to further personalize results. In some implementations, the systems and methods may include an image combination tool for combining images (e.g., merging multiple photos (e.g., food, landscapes, activities, etc.) to create a unique vision), performing visual search (e.g., finding destinations that offer a combination of the desired elements), and/or perform other tasks (e.g., finding restaurants with specific dish combinations and/or discovering destinations with multiple activities).

The personalization model may leverage a task graph (e.g., an embedding representation of a user's preferences) for machine-learning for personalized recommendations. For example, the personalization model may leverage location history, social media activity, ratings, and/or explicitly stated preferences to tailor suggestions. The task graph may include a taste graph that is descriptive of a representation that was built based on a profile of the user's aesthetic and activity preferences over time.

Additionally and/or alternatively, the image generation and/or the search result determination may be based at least in part on user data. The user data can include a user location history, social media activity, ratings (e.g., ratings on different map application listings of different locations), user preferences, browsing history, search history, trip history, and/or other user data.

The systems and methods may leverage and/or communicate with a destination database. The destination database may include images, descriptions, and/or details (e.g., location, cost, reviews, etc.) for a plurality of different locations.

In some implementations, the systems and methods may leverage application programming interfaces (APIs). The application programming interfaces may be utilized for visual search, image matching, direct booking integration, social media data transmittal/retrieval (e.g., obtaining user data and/or preferences), and/or other API calls. In some implementations, a feedback loop may be utilized to obtain user ratings and feedback to improve recommendations and/or algorithm accuracy.

A user can input descriptors descriptive of their dream destination through text, image, and/or voice inputs. The AI Engine(s) of the system can generate a visual representation of the dream destination using image diffusion models. The location matching engine can leverage a visual search API to find real-world destinations that closely match the generated image. The user interface of the system can display the matching destinations, along with 360° views and/or additional information. A taste graph (e.g., a learned embedding representation of a user's interests (and/or tastes)) can be leveraged to personalize recommendations based on user data and feedback.

In some implementations, the systems and methods can include interactive exploration via one or more user interface elements. The interactive exploration may include three-hundred sixty degree views of the model-generated environments and/or the search result locations. For example, the interactive exploration may offer immersive virtual tours of recommended destinations. The interactive exploration may provide detailed information for display, which may include providing essential details like travel distance, cost estimates, local attractions, and/or reviews.

The systems and methods may be provided via a map application, a search application, a virtual-reality application, and/or an image generation application. For example, a map application may have an entry point for generating synthetic images that can then be searched, and the search results may then be provided for display with a map annotation and/or other location information. Additionally and/or alternatively, a search application may have an entry point for generating synthetic images that can then be searched, and the search results may then be provided for display within a search results interface. A virtual-reality application may have an entry point for generating synthetic images that can then be searched, and the search results may be a virtual-reality asset that can then be provided for display to the user. An image generation application may have an entry point for searching the model-generated images, and the search results may then be provided for display within a search results interface. Alternatively and/or additionally, the image generation application may store the model-generated images generated based on user-provided prompts in one or more collections. The stored model-generated images may be searched in the backend. In response to the search results, the image generation application may provide one or more selectable action user interface elements, which may be selectable to navigate to a search results page, perform a particular action (e.g., book a restaurant reservation, book a hotel, book a flight, invoke a virtual-reality application, and/or other actions determined based on the results of the search), and/or augment the query to include further context (e.g., to generate a multimodal query that includes the model-generated image and one or more additional inputs). In some implementations, the search may be proactively performed in the backend. The image generation application may learn styles and/or preferences associated with the user and may proactively generate new synthetic images without a user-provided prompt. The new synthetic image may then be searched to provide proactive search suggestions (e.g., content suggestions and/or query suggestions).

In some implementations, the systems and methods may generate a three-hundred and sixty degree rendering of a model-generated environment, in which the model-generated environment is rendered based on a search query (and/or prompt input). The three-hundred and sixty degree rendering can then be provided to the user via a virtual-reality experience and/or a viewing window of a user interface. Eye tracking (e.g., iris tracking) may then be performed to determine a sub-portion of the three-hundred and sixty degree rendering to search. Alternatively and/or additionally, a manual user input may be received to determine a sub-portion of the three-hundred and sixty degree rendering to search. The systems and methods may search one model-generated image, a plurality of model-generated images, and/or the entire three-hundred and sixty degree panorama.

In some implementations, an itinerary may be generated based on the location search results. The itinerary may be generated by iteratively generating and searching synthetic images to determine different attractions and/or locations of interest to the user.

The systems and methods of the present disclosure provide a number of technical effects and benefits. As one example, the system and methods can provide an interactive user interface that can be utilized machine-learned model output leveraged search. In particular, the systems and methods disclosed herein can leverage a machine-learned model to generate an output that can then be utilized as a query to query a search engine. For example, the systems and methods can provide a prompt input to an image generation model, which can generate a plurality of model-generated images. A user can then select one or more model-generated images that are in line with a desired product or object. The selected model generated image(s) can then be input into a search engine, which can output one or more search results associated with environments, settings, and/or objects that are determined to be similar to the provided image. The present disclosure can enable search and retrieval of search results in a more efficient and/or faster manner. In particular, the present disclosure can enable more versatile search and retrieval of search results based on different kinds of input. In the present disclosure, a selection of one or more images may be used to determine search results. Moreover, in the present disclosure, the one or more images may be model-generated by an image generation model. This can inherently expand the versatility of search and retrieval through expanding the range of inputs that can be provided as part of a search and retrieval process. The systems and methods can enable search and retrieval of search results based on images that may not previously have been in existence, but which may have been newly generated for this purpose. This can provide a mechanism for inputting a search query which would not be possible without the implementation of the image generation model to the overall process as described herein. The present disclosure thereby can leverage an image generation model in combination with determination of search results to provide improved search and retrieval operations.

Another technical benefit of the systems and methods of the present disclosure is the ability to leverage one or more user interface elements to provide suggested inputs for the machine-learned model. For example, a plurality of category user interface elements can be provided with each user interface element being associated with a different category for dataset generation. A plurality of descriptor user interface elements can be provided to allow for more detailed prompt generation. The plurality of descriptor user interface elements may be provided for display and/or refined based on the selection of a particular category. The different user interface elements may lead to more directed prompt generation based on terms the model may be trained on specifically. Moreover, the increased versatility of the search and retrieval process according to the present disclosure can enable faster and/or more accurate determination of requested search results. Text queries to a search engine may provide mixed and/or unaligned search results that may be off topic and/or may include only parts of the search query. Repeated iterations of updating text queries and searching may lead to high use of processor power, high use of available bandwidth, and high consumption of battery of a user device. The present disclosure can enable more versatile input to a search engine based on model-generated images. This can provide improved accuracy, tailoring or targeting of the input search query, which further enables more efficient use of processor power, available bandwidth and battery in a search and retrieval operation.

Another example of technical effect and benefit relates to improved computational efficiency and improvements in the functioning of a computing system. For example, the systems and methods disclosed herein can leverage cloud computing to provide an immersive artificial intelligence leveraged capability to user devices with limited computational capabilities.

With reference now to the Figures, example embodiments of the present disclosure will be discussed in further detail.

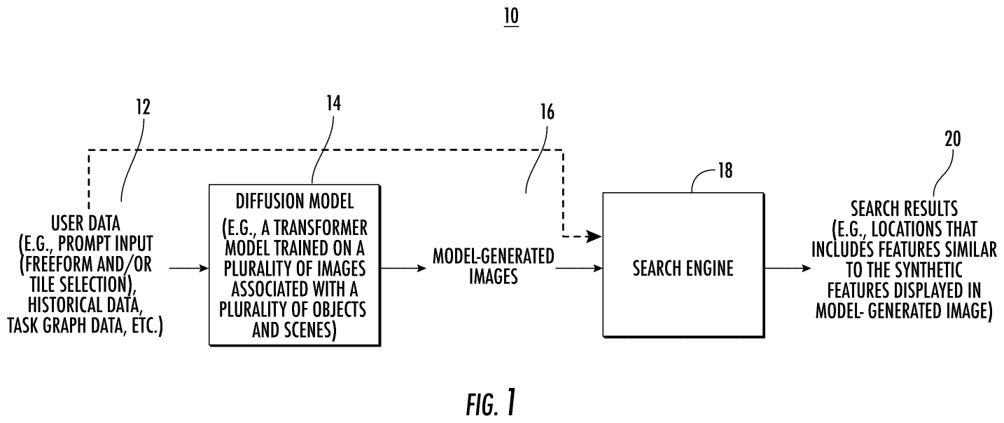

FIG. 1 depicts a block diagram of an example model-generated image search system 10 according to example embodiments of the present disclosure. In particular, the model-generated image search system 10 can include obtaining user data 12, generating one or more model-generated images 16, and determining one or more search results 20 based on the one or more model-generated images 16.

For example, user data 12 can be obtained from a user computing system. The user data can include a prompt input, historical data (e.g., data descriptive of user search history, user purchase history, user browsing history, etc.), profile data, user-selected data, and/or preference data. The prompt input can include a freeform prompt input and/or a generated prompt input generated based on one or more tile selections of a user interface. The prompt input can be descriptive of one or more attributes a user is requesting to be rendered in a generated image. The prompt input can include a subject of the image (e.g., an environment and/or one or more objects) and one or more details for the subject (e.g., a color, a style, a material, a plant, a structure, an animal, a food, an attraction, etc.).

The user data 12 can be processed with a diffusion model 14 to generate one or more model-generated images 16. The diffusion model 14 can be a machine-learned image generation model and may be trained to process text data and/or image data to generate one or more images. The one or more model-generated images 16 can include an environment with one or more attributes (e.g., one or more objects, which may include particular structures, plants, animals, and/or other features) and may be associated with the descriptors and one or more details of the prompt input.

The one or more model-generated images 16 can then be provided to a search engine 18 to determine one or more search results 20. The one or more model-generated images 16 may be provided to the search engine 18 automatically upon generation and/or may be provided in response to one or more user inputs (e.g., a selection of a search option and/or a selection of a particular image). In some implementations, the search engine 18 may additionally process the user data 12 with the one or more model-generated images 16 to determine the one or more search results 20. The one or more search results 20 may be determined based on one or more visual similarities between the one or more model-generated images 16 and one or more images associated with the one or more search results 20. The search results 20 can include location search results (e.g., map search results), image search results, website search results, and/or marketplace search results. For example, the search results 20 may include locations determined to be visually similar to one or more synthetic environments depicted in the one or more model-generated images 16.

In particular, the model-generated image search system 10 can obtain user data 12 descriptive of environment descriptors that may be of interest to a user (e.g., based on explicit inputs, learned preferences, and/or availability). The model-generated image search system 10 may generate a visualization of the environment (e.g., the one or more model-generated images 16). A user may select a specific image that is of interest to them. The model-generated image can then be provided to a search engine 18 to determine real world products that are visually similar to the “imagined” destination.

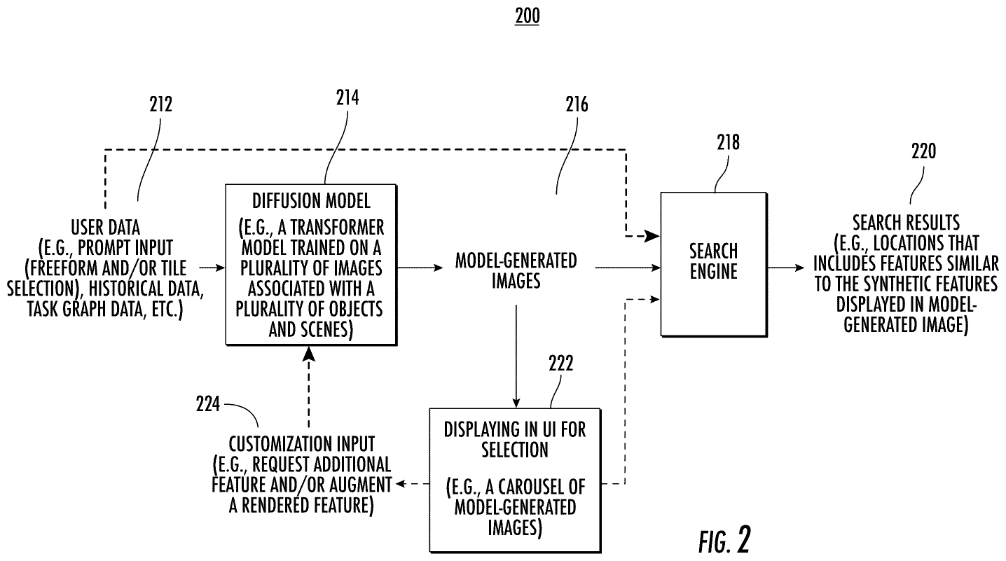

FIG. 2 depicts a block diagram of an example model-generated image search and customization system 200 according to example embodiments of the present disclosure. In particular, the model-generated image search and customization system 200 can include obtaining user data 212, generating one or more model-generated images 216, and determining one or more search results 220 based on the one or more model-generated images 216.

For example, user data 212 can be obtained from a user computing system. The user data can include a prompt input, historical data (e.g., data descriptive of user search history, user purchase history, user browsing history, etc.), profile data, and/or preference data. The prompt input can include a freeform prompt input and/or a generated prompt input generated based on one or more tile selections of a user interface. The prompt input can be descriptive of one or more attributes a user is requesting to be rendered in a generated image. The prompt input can include a subject of the image (e.g., an environment and/or one or more objects) and one or more details for the subject (e.g., environment descriptors, a color, a style, a material, etc.).

The user data 212 can be processed with a diffusion model 214 to generate one or more model-generated images 216. The diffusion model 214 can be a machine-learned image generation model and may be trained to process text data and/or image data to generate one or more images. The one or more model-generated images 216 can include a subject with one or more attributes and may be associated with the subject (e.g., the environment and/or setting) and one or more details of the prompt input.

The one or more model-generated images 216 can then be provided to a search engine 218 to determine one or more search results 220. The one or more model-generated images 216 may be provided to the search engine 218 automatically upon generation and/or may be provided in response to one or more user inputs (e.g., a selection of a search option and/or a selection of a particular image). In some implementations, the search engine 218 may additionally process the user data 212 with the one or more model-generated images 216 to determine the one or more search results 220. The one or more search results 220 may be determined based on one or more visual similarities between the one or more model-generated images 216 and one or more images associated with the one or more search results 220. The search results 220 can include location search results, virtual-reality asset search results, image search results, website search results, and/or marketplace search results. For example, the search results 220 may include destinations determined to be visually similar to one or more environment features depicted in the one or more model-generated images 216.

In particular, the model-generated image search and customization system 200 can obtain user data 212 descriptive of an item that may be of interest to a user (e.g., based on explicit inputs, learned preferences, and/or availability). The model-generated image search and customization system 200 may generate a visualization of the environment (e.g., the one or more model-generated images 216). A user may select a specific image that is of interest to them. The model-generated image can then be provided to a search engine 218 to determine real world products that are visually similar to the “imagined” destination.

The model-generated images 216 may be provided for display in a user interface for selection 222. The one or more model-generated images 216 may be provided via a carousel interface, a thumbnail interface, a slideshow interface, and/or a collage interface. A user may select a particular model-generated image to search. Alternatively and/or additionally, a user may input a customization input 224 to generate a new set of model-generated images. The customization input 224 can include adding one or more features to a generated model-generated image, replacing one or more existing features, deleting one or more features, and/or augmenting the prompt input to include one or more additional prompt terms and/or prompt images. For example, a user may request a model-generated image of a dress be augmented based on an input image of a particular pattern. The model-generated image and the input image may be processed by the diffusion model 214 to generate an augmented image that may then be provided for display and/or searched.

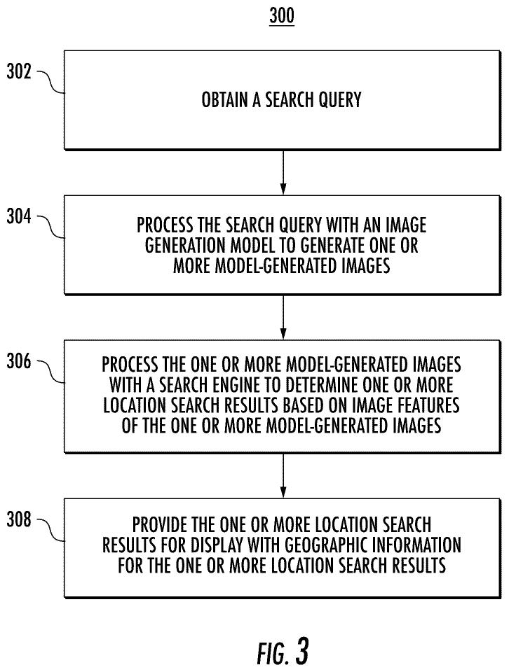

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain a search query. The search query can include a plurality of search terms. The plurality of search terms can include a plurality of different environment descriptors. In some implementations, the search query may be descriptive of a setting with one or more objects (e.g., “a beach with pine trees” or “a city with gothic cathedrals”). The search query may be obtained via a query input box of a search interface. The search interface may include a graphical interface that is configured to receive queries and output search results. In some implementations, the search interface may include a toggle user interface element and/or one or more suggested options for generating synthetic images that can then be searched.

At 304, the computing system can process the search query with an image generation model to generate one or more model-generated images. The one or more model-generated images can include a plurality of predicted pixels descriptive of a predicted rendering of a model-generated environment comprising each of the plurality of different environment descriptors (e.g., a synthetic rendering of a beach that includes pine trees or a city corner that includes a side view of a large gothic cathedral). The image generation model can include a generative model trained for text-to-image generation. The generative model may include a diffusion model and may include one or more transformer models. The toggle user interface element and/or one or more suggested options of the search interface may be selected and/or provided in response to generating the one or more model-generated images. The one or more model-generated images may differ from the training images utilized to train the image generation model.

In some implementations, processing the search query with the image generation model to generate the one or more model-generated images can include generating a plurality of different candidate model-generated images based on processing the search query with the image generation model, evaluating the plurality of different candidate model-generated images to generate a plurality of respective image scores, and determining the one or more model-generated images of the plurality of different candidate model-generated images to provide to the search engine based on the plurality of respective image scores. The plurality of respective image scores can be determined based on processing each of the plurality of different candidate model-generated images with one or more classification models to determine whether a respective candidate model-generated image comprises each of the plurality of different environment descriptors. The plurality of respective image scores may be determined based on evaluating each of the plurality of different candidate model-generated images on one or more benchmarks for realism and hallucinations. The candidate model-generated image selection may be performed in the back-end and may include only outputting a subset of the candidates for display.

Alternatively and/or additionally, processing the search query with the image generation model to generate the one or more model-generated images can include generating a plurality of different initial model-generated images based on processing the search query with the image generation model and mosaicking the plurality of different initial model-generated images to generate the one or more model-generated images. For example, the mosaicking can include processing the plurality of different initial model-generated images with the image generation model and/or a second machine-learned model to stitch together the plurality of different initial model-generated images to generate an expanded image. In some implementations, the one or more model-generated images may include a three-hundred and sixty degree rendering that may be utilized for a virtual-reality display.

At 306, the computing system can process the one or more model-generated images with a search engine to determine one or more location search results based on image features of the one or more model-generated images. The one or more location search results can be associated with one or more model-generated environment features depicted in the one or more model-generated images. The one or more location search results can include geographic locations and respective details associated with the geographic locations (e.g., an address, relevant websites, relevant ratings, etc.). The one or more model-generated images can include one or more three-hundred and sixty degree renderings of the model-generated environment comprising each of the plurality of different environment descriptors.

In some implementations, processing the one or more model-generated images with the search engine to determine the one or more location search results based on the image features of the one or more model-generated images can include determining a sub-portion of the one or more three-hundred and sixty degree renderings of the model-generated environment is being viewed when a search invoking element is selected, segmenting the sub-portion of the one or more three-hundred and sixty degree renderings of the model-generated environment, and providing the sub-portion of the one or more three-hundred and sixty degree renderings of the model-generated environment to the search engine to determine the one or more location search results. Determining the sub-portion may include eye tracking, obtaining manual selections, determining a focal point upon selection of a search trigger user interface element, and/or other techniques.

At 308, the computing system can provide the one or more location search results for display with geographic information for the one or more location search results. The one or more location search results may be provided for display within the search interface and may be provided within a search results page. The geographic information may include navigational directions, addresses, contact information, and/or other details.

In some implementations, the computing system can provide an interactive user interface for providing an interactive window for viewing different portions of the one or more three-hundred and sixty degree renderings of the model-generated environment comprising each of the plurality of different environment descriptors.

Additionally and/or alternatively, the computing system can obtain a task graph associated with a particular user that provided the search query. The task graph can include a learned embedding representation associated with learned interests of the user. In some implementations, processing the search query with the image generation model to generate the one or more model-generated images can include processing the search query and the task graph with the image generation model to generate the one or more model-generated images. The task graph may be learned based on learning edges and nodes associated with the learned embedding representation by embedding search history instances of the particular user to generate a plurality of nodes and determining a plurality of edges by determining interlinking groupings between the plurality of nodes.

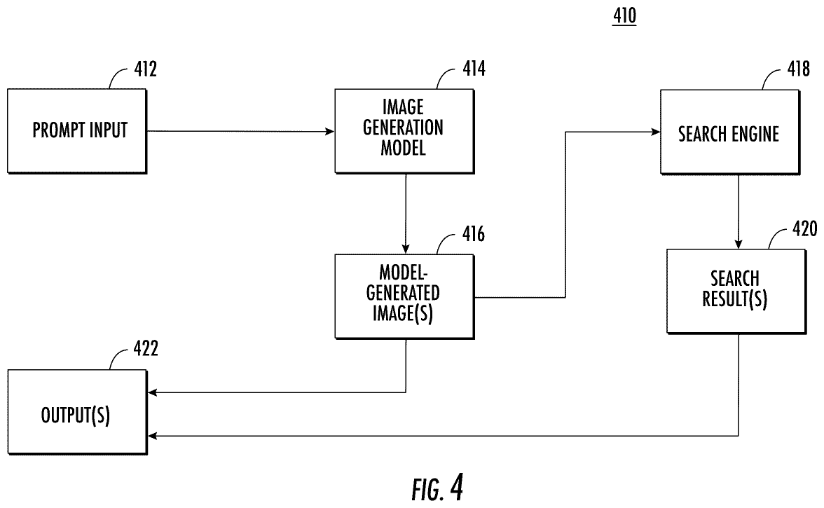

FIG. 4 depicts a block diagram of an example model-generated image search system 410 according to example embodiments of the present disclosure. In particular, FIG. 4 depicts a model-generated image search system 410 that obtains a prompt input 412, generates one or more model-generated images 416 with an image generation model 414 based on the prompt input 412, and performs a search based on one or more of the model-generated images 416.

For example, a prompt input 412 can be obtained from a user computing device. The prompt input 412 can be descriptive of one or more terms and/or one or more images. The prompt input 412 may be generated based on freeform text entry, file upload, and/or based on a plurality of user interface chip selections. The prompt input 412 may be processed with a prompt generation block to generate an input for a specific machine-learned model. Alternatively and/or additionally, the prompt input 412 may be processed by an embedding model to generate a text embedding to be provided to a transformer model trained to generate images based on text embeddings.

The prompt input 412 can be processed with an image generation model 414 to generate one or more model-generated images 416. The one or more model-generated images 416 can be generated based on the prompt input 412. For example, the one or more model-generated images 416 can depict one or more features associated with one or more prompt terms (e.g., a building with columns in a forest can be depicted in response to the selection of a “forest” descriptor user interface element and a “columns” descriptor user interface element).

A user can then select one or more of the one or more model-generated images 416 to be utilized as an image query. The selected image(s) can be provided to a search engine 18. One or more search results 420 can then be received from the search engine 418. The one or more search results 420 can be descriptive of preexisting data that is similar to the model-generated data.

The one or more model-generated images 416 and/or the one or more search results 420 can be provided to a user as an output 422. The user can then store the output(s) 422 can be stored in a collection and/or shared with one or more other users.

The model-generated image search system 410 can provide an interface for imagining and finding clothing, art, travel locations, videos, music, and/or other objects or content items.

In some implementations, the systems and methods can include utilizing the model-generated data (e.g., one or more model-generated images) to generate an augmented-reality rendering asset and/or a virtual-reality experience. For example, the generative model (e.g., the image generation model) may process a prompt to generate an augmented-reality rendering asset and/or a virtual-reality experience. In some implementations, a prompt may be processed by an image generation model to generate one or more model-generated images that can then be utilized to generate an augmented-reality rendering asset and/or a virtual-reality rendering experience. The augmented-reality rendering asset can be utilized to render the model-generated object into a user's environment. For example, a user can utilize the augmented-reality rendering asset to render the model-generated object into their room and/or onto their body. The rendering can be performed on still images and/or a live camera feed. Additionally and/or alternatively, the virtual-reality experience can be utilized for viewing the one or more objects in a three-dimensional virtual space.

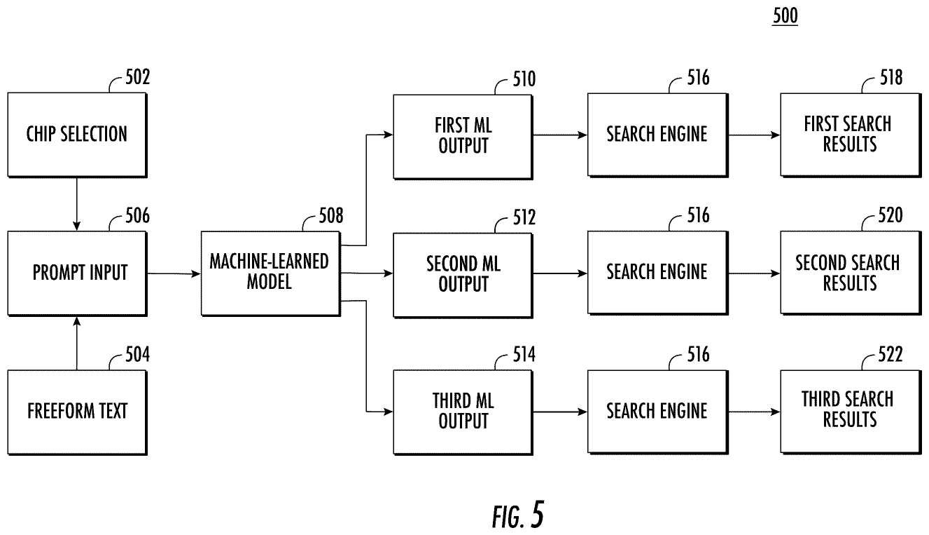

FIG. 5 depicts a block diagram of an example machine-learned model processing and search system 500 according to example embodiments of the present disclosure. In particular, the machine-learned model processing and search system 500 includes generating a prompt input 506, providing the prompt input 506 to a machine-learned model 508 (e.g., a dataset generation model) to receive a plurality of machine-learned model outputs (e.g., a plurality of model-generated datasets), obtaining a selection input, providing the selected machine-learned model output to a search engine 516, and receiving one or more search results.

The prompt input 506 can be generated and/or determined based on one or more chip selections 502, one or more freeform text inputs 504, and/or one or more media file inputs. For example, a plurality of user interface chips associated with different candidate prompt terms can be provided for display. A user can then select a subset of the plurality of user interface chips, which can then be utilized to generate a prompt input 506 that is descriptive of the plurality of selected prompt terms. In some implementations, the prompt input 506 can include prompt terms input via freeform text 504.

The prompt input 506 can then be processed with a machine-learned model 508 (e.g., a dataset generation model (e.g., an image generation model)) to generate plurality of machine-learned model outputs (e.g., a plurality of images). The plurality of machine-learned model outputs can include a first machine-learned model output 510 (e.g., a first model-generated image), a second machine-learned model output 512 (e.g., a second model-generated image), and a third machine-learned model output 514 (e.g., a third model-generated image).

A user may then select a particular machine-learned model output to utilize for searching for resources (e.g., for searching for travel destinations, for searching for restaurants, and/or for searching for another type of destination). For example, the first machine-learned model output 510 may be input into a search engine 516 to obtain one or more first search results 518, the second machine-learned model output 512 may be input into a search engine 516 to obtain one or more second search results 520, and the third machine-learned model output 514 may be input into a search engine 516 to obtain one or more third search results 522. The search results can be determined based on a determined similarity score.

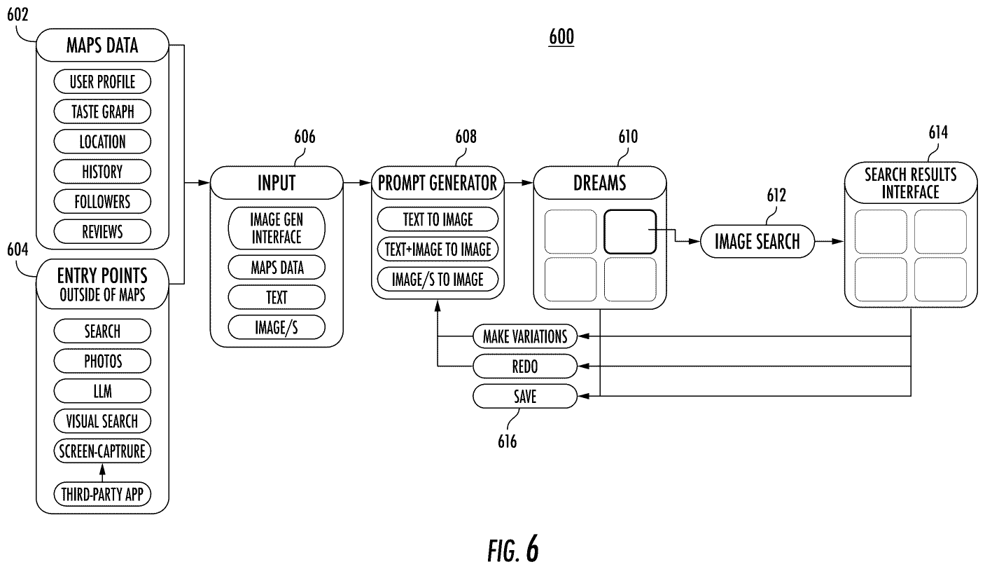

FIG. 6 depicts a block diagram of an example generative artificial intelligence-leveraged search system 600 according to example embodiments of the present disclosure. In particular, the generative artificial intelligence-leveraged search system 600 can obtain and/or generate inputs 606, which can then be processed to generate a search results interface 614.

The inputs 606 can be obtained via an image generation interface, which may be invoked in response to a selection and/or triggering of an entry point 604 user interface element/transition. The entry points 604 may include entry from a search interface, a photos interface (e.g., an image gallery application), a language model interface (e.g., a chat bot application), a visual search interface, a screen-capture interface, and/or a third-party application. In some implementations, the inputs 602 may include map data 602. The map data 602 may include user profile data, taste graph data associated with the user and/or a group of users, a user location, a user history (e.g., location history, search history, interaction history, and/or browsing history), social media activity, followers, reviews, and/or geographic information. The inputs 606 may be obtained via user interface elements of an image generation interface. Additionally and/or alternatively, the inputs 606 may include text data, image data, audio data, latent encoding data, multimodal data, and/or other data.

The inputs 606 may be processed with a prompt generator 608 to generate a prompt input. The prompt input can then be processed with a text-to-image generation model (e.g., a diffusion model) to generate one or more model generated images 610. The prompt input may include text, one or more images, text and images, and/or other data combinations. The image generation model may perform text-to-image generation, text & image to image generation, images to image generation, and/or another image generation format. The prompt input generation may include processing the inputs 606 with a natural language processing model to determine a semantic intent. One or more prompt templates can then be obtained based on the determined semantic intent. The prompt template can then be augmented based on parsing and/or tokenizing the inputs 606 to extract the descriptors that can then be placed within the prompt template to generate the prompt input.

The one or more model-generated images 610 can then be stored in a collections interface and/or cached. The one or more model-generated images 610 can then be searched via an image search 612 (e.g., an image-to-image search, an embedding based search, a reverse image search, and/or other search technique) to determine one or more location search results.

The one or more location search results can then be provided for display within a search results interface 614. The search results interface may include a map annotated based on the location search results, may display the one or more model-generated images, may display geographic information, may include travel directions for traveling to the one or more search results, an itinerary generated with a large language model and based on the one or more location search results, and/or other search result details.

The search results interface 614 and/or the collections interface may include interface options 616 for making synthetic image variations (e.g., making variations of the one or more model-generated images), redo the input obtainment and/or image generation, and/or saving the location search results and/or one or more model-generated images.

Some aspects of the present disclosure may be directed to training and/or tuning machine-learned models based on intent determinations from provided queries. In particular, intents of provided queries may be determined via a generative language model (e.g., large language models (LLMs), vision language models (VLMs), etc.), and the determined intents may be utilized to evaluate a loss function for training query embedding models and/or adjusting an intent graph (and/or a task graph that maps query clusters to particular tasks). A prompt generator model may process a query as input and generate a query embedding that maps the query to an embedding space associated with an intent graph that includes a plurality of learned distributions and/or query clusters associated with an intent graph. For example, a query embedding model may process a query and map the query to an intent embedding space associated with queries associated with similar query intents.

In some implementations, the embedding model may be tuned using a generative language model and a loss function. The loss function may process a query embedding and an intent determination from a generative model. The loss function may determine a loss between the query embedding and the intent determination which may be used to improve the query embedding model. For instance, the gradient descent of the loss between the query embedding and the intent determination may be backpropagated to the query embedding model to adjust one or more parameters of the query embedding model. The embedding model can be trained and/or tuned to generate query embeddings that are associated with (e.g., proximate to and/or similar to) embeddings of the intents associated with the query and other query embeddings with similar intents. By leveraging the intent determination of the generative model, the embedding model can be trained to generate similar embeddings for a query and a respective intent for the query, which can incentivize intent-based distributions.

The systems and methods can determine a query embedding cluster (and/or prompt input cluster) associated with the query embedding. The query embedding cluster may be a cluster of embeddings associated with a plurality of different queries with a similar query intent to the multi-turn aware query. The query embedding cluster may be associated with a node within a task graph, the task graph being a data graph including a plurality of nodes associated with a plurality of different query tasks. In some implementations, the query embedding cluster may include a plurality of different queries associated with one or more shared attributes, and the one or more shared attributes may be associated with one or more query intents. For example, a query embedding cluster may include a plurality of different queries that share attributes (e.g., having the same topic, “smartphone cases,” having a similar intent, “buying a smartphone case”, and/or having the same type of intent, “a consumer-facing intent” and/or “a late stage buying intent”).

The systems and methods disclosed herein can include using a generative model (e.g., an LLM) to rewrite a search query to a more complete prompt input by obtaining and processing user data. Additionally and/or alternatively, the systems and methods can include using an intent graph (e.g., an (LLM-powered) task graph) and a dual-encoder intent mapping model to map the rewritten query into a query intent space.

The contextually aware prompt (e.g., the augmented query) can further be used as input to do Query Intent-DR to map the query to one of the intent spaces in an intent graph (e.g., a task graph). In some implementations, the systems and methods can accurately represent the contextual intent of the user query in an intent representation, which can directly be utilized in various content item retrieval systems.

In some implementations, the systems and methods can include using a generative model (e.g., an LLM) to further improve current intent models such as an intent graph (e.g., a task graph/query intent representation).

The intent models can be built based on user behavioral signals (e.g., clustering queries that have similar click distribution in a search interface). In some implementations, the one or more intent models can include an “encoder LLM” model to discover relevant queries in parallel to click signals to train and/or tune the intent model.

For example, the systems and methods can include using an LLM to further provide richer attributes on learning an intent space (e.g., task graph nodes and edges), such as commercial attributes of intent and/or next-step intent discovery.

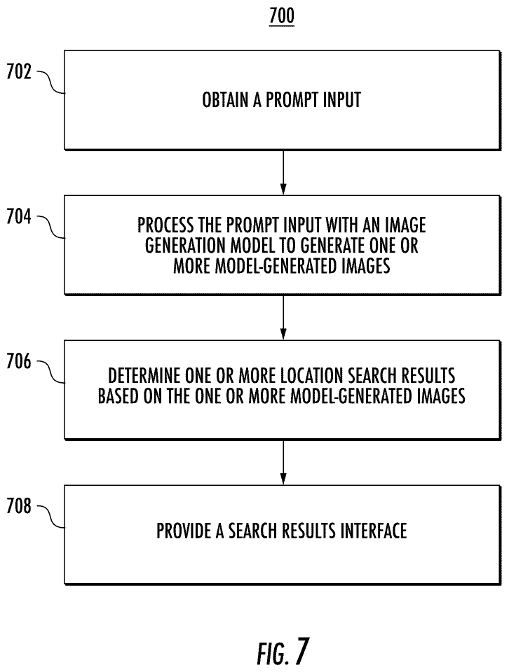

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain a prompt input. The prompt input can include a plurality of terms. In some implementations, the plurality of terms can include a description of a plurality of different environmental characteristics. The prompt input may be obtained via an image generation interface, a search interface, and/or other user interface. The prompt input may include a natural language hard prompt and/or a vector-based soft prompt. The prompt input may include one or more feature tokens. In some implementations, the prompt input may be tokenized and/or pre-processed to generate a refined prompt input. The refined prompt input may be generated based on determining a semantic intent of the prompt input, obtaining a particular prompt template based on the semantic intent, and generating the refined prompt input based on augmenting the prompt input based on the particular prompt template.

At 704, the computing system can process the prompt input with an image generation model to generate one or more model-generated images. The one or more model-generated images can be generated based at least in part on the plurality of terms. In some implementations, the image generation model may have been trained to process text data to generate one or more images including predicted pixels associated with features described with the text data. The text data can be descriptive of a plurality of different environment features. The image generation model may be trained for multimodal processing. For example, the prompt input may include a multimodal input that includes text and one or more images. The image generation model may generate one or more augmented images based on generating predicted replacement pixels for at least a portion of the one or more images in which the predicted replacement pixels are generated based on the text (and/or one or more image features of the one or more images) of the multimodal input.

In some implementations, the plurality of terms can describe a particular type of terrain (e.g., hill, mountain, ocean, beach, plain, tundra, forest, glacier, etc.) and a particular type of plant (e.g., a pine tree, a hydrangea, a palm tree, a lily, a particular type of fern, etc.). The one or more model-generated images can depict a rendering of the particular type of plant within the particular type of terrain. In some implementations, the combination may differ from any terrain and plant combination depicted within the plurality of training images for the image generation model.

Additionally and/or alternatively, the plurality of terms may describe a particular type of architecture (e.g., gothic, baroque, modern, Victorian, classical, contemporary, etc.) and a particular type of climate (e.g., desert, humid, arid, tropical, dry, polar, etc.). The one or more model-generated images may depict a rendering of the particular type of architecture within the particular type of climate. The depiction of the climate may be rendered based on determining environmental features associated with the climate.

Alternatively and/or additionally, the plurality of terms may describe a first attraction type (e.g., a museum, a roller coaster, a monument, a nature view, etc.) and a second attraction type (e.g., a museum, a roller coaster, a monument, a nature view, etc.). The one or more model-generated images may depict a rendering of a model-generated environment that comprises the first attraction type and the second attraction type.

At 706, the computing system can determine one or more location search results based on the one or more model-generated images. The one or more location search results can be associated with one or more model-generated environment features depicted in the one or more model-generated images. The one or more location search results may include a particular address, a particular region, and/or a particular city. The one or more location search results may be ranked, determined, and/or filtered based on a user's location, aa user's preferences, and/or one or more learned user preferences.

At 708, the computing system can provide a search results interface. The search results interface can provide the one or more location search results for display with geographic information for the one or more location search results. The search results interface may include a plurality of different panels. The plurality of different panels may include image search results, web search results, a knowledge panel, and/or other detail-based panels. The plurality of different panels may include separate panels for search results determined based on the text of the prompt input and search results determined based on the one or more model-generated images.

In some implementations, the computing system can obtain location data associated with a user location, determine one or more travel options for traveling from the user location to one or more destination locations associated with the one or more location search results, and provide the one or more travel options for display.

Additionally and/or alternatively, for each of the one or more location search results, the computing system can determine a plurality of attractions associated with a respective location associated with a respective location search result, generate a respective itinerary for the respective location search result, and provide the respective itinerary for display within the search results interface. The respective itinerary can include a schedule for attending at least a subset of the plurality of attractions.

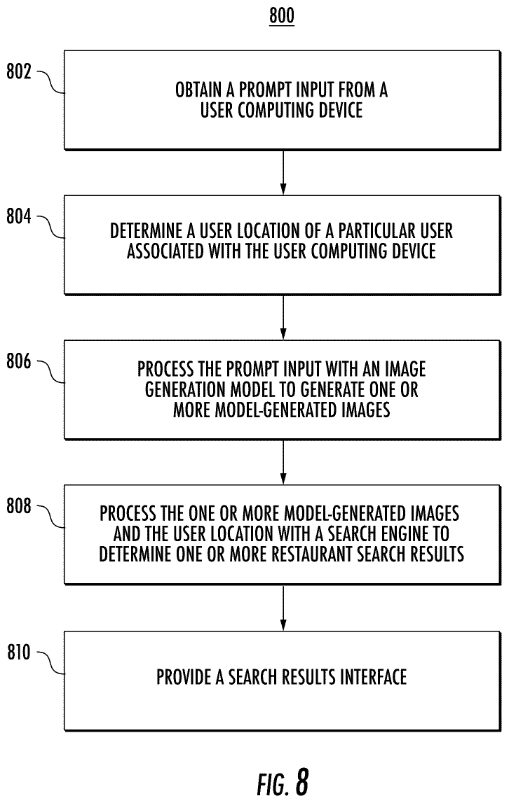

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a prompt input from a user computing device. The prompt input can include a plurality of terms. In some implementations, the plurality of terms can include a description of a plurality of different food items. The description can include specific food names, food type descriptors, aesthetic descriptors, and/or a food region descriptor.

At 804, the computing system can determine a user location of a particular user associated with the user computing device. The user location determination may be based on a user computing device, recent searches, and/or other obtained data.

At 806, the computing system can process the prompt input with an image generation model to generate one or more model-generated images. The one or more model-generated images can be generated based at least in part on the plurality of terms. In some implementations, the image generation model may have been trained to process text data to generate one or more images comprising predicted pixels associated with food characteristics described with the text data. The text data can be descriptive of a plurality of different features. The plurality of terms can further include an aesthetic description. The one or more model-generated images can include a rendering of the plurality of model-generated food items within a model-generated environment that comprises the aesthetic description. In some implementations, the one or more model-generated images can depict a first food item of a first food type and a second food item of a second food type. The one or more model-generated images may include a rendering of a model-generated menu that includes the plurality of model-generated food items.

At 808, the computing system can process the one or more model-generated images and the user location with a search engine to determine one or more restaurant search results. The one or more restaurant search results can be associated with a plurality of model-generated food items depicted in the one or more model-generated images. In some implementations, the one or more restaurant search results can be within a threshold distance from the user location. The one or more restaurant search results may be determined based on an image feature search, which may include an embedding-based search. In some implementations, the one or more model-generated images may be processed with a classification model to generate one or more food classification labels. The one or more food classification labels can then be cross-checked against respective menus for the one or more restaurant search results to filter and/or rank the search results.

At 810, the computing system can provide a search results interface. The search results interface can provide the one or more restaurant search results for display with geographic information for the one or more restaurant search results. The search results interface may include one or more action user interface elements, which may be selectable to contact a restaurant associated with the one or more restaurant search results.

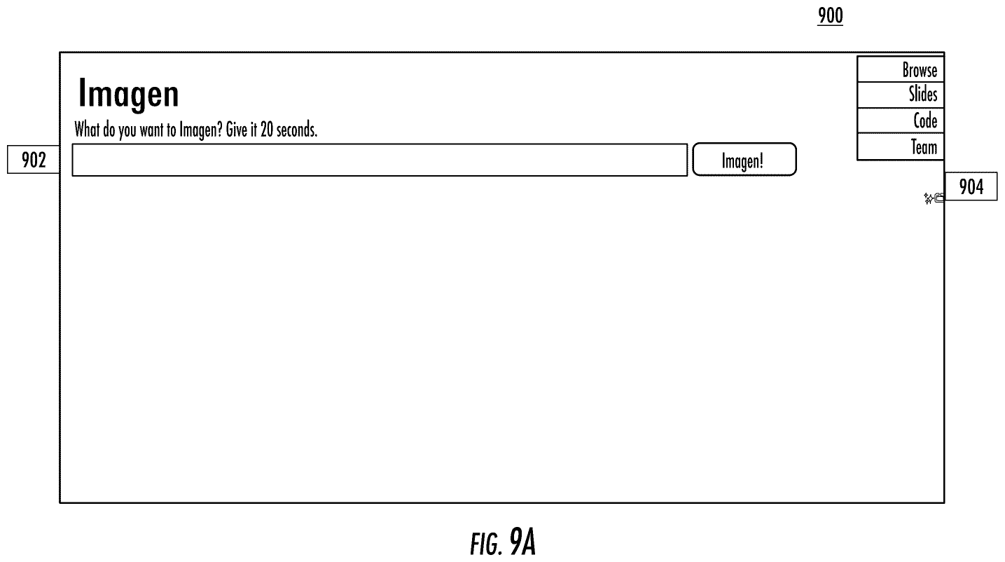

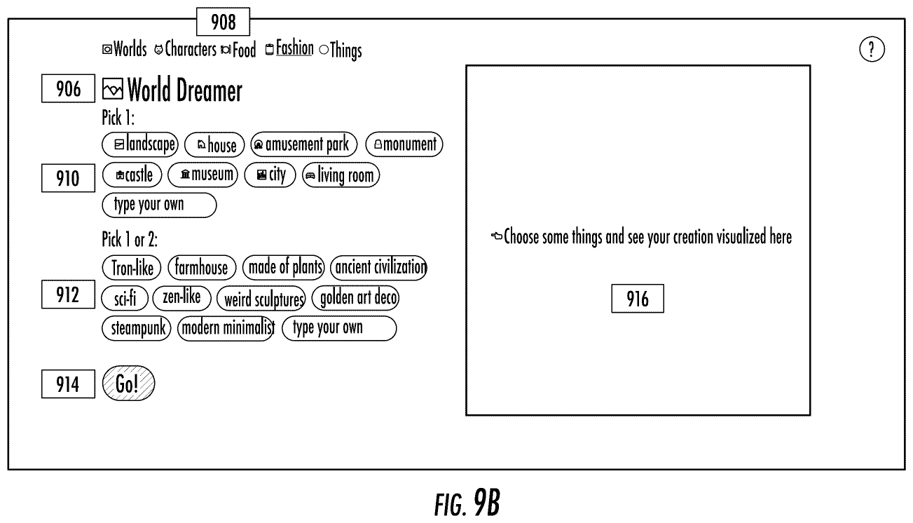

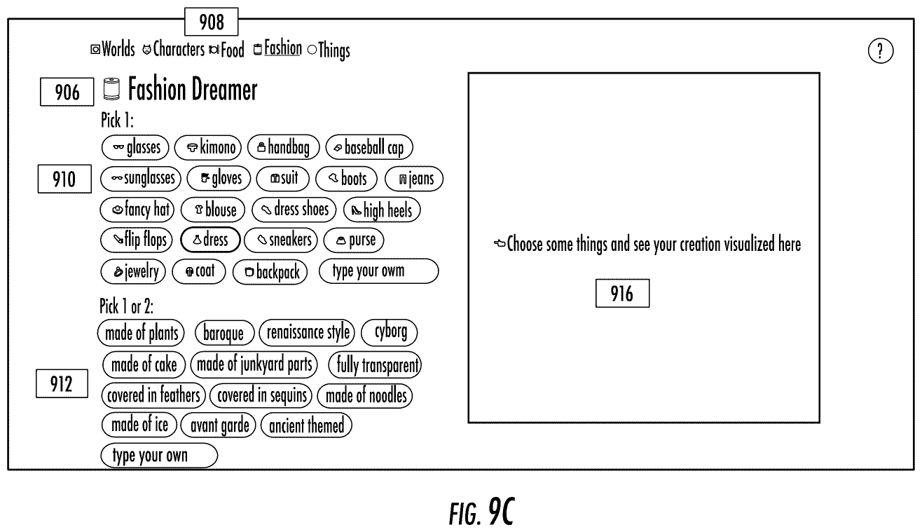

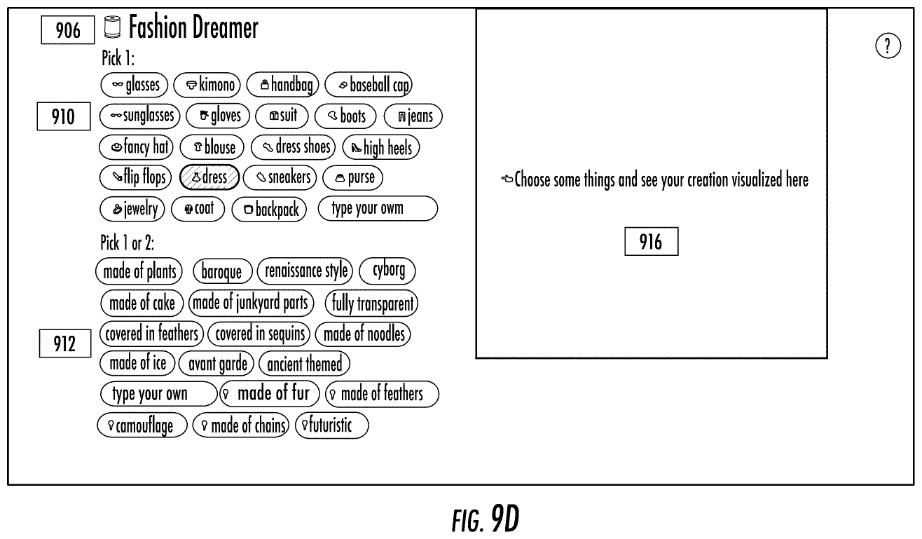

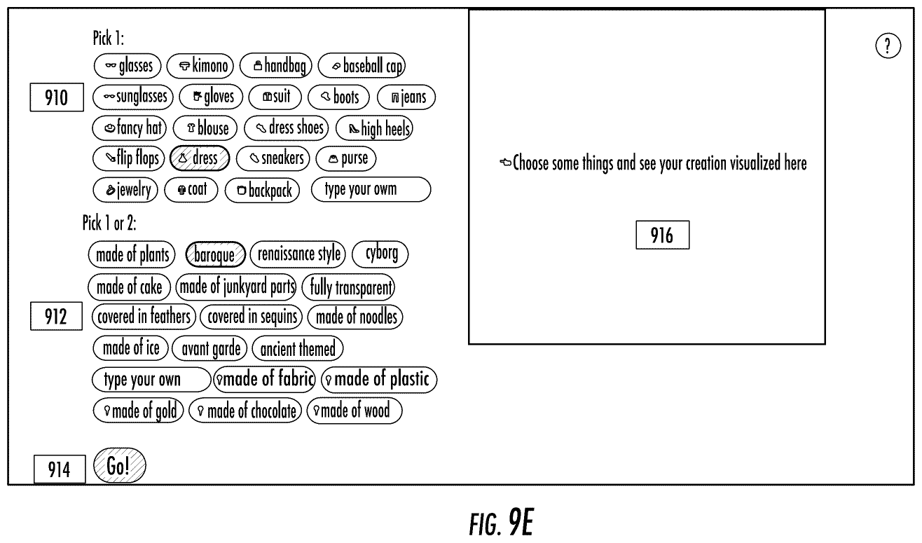

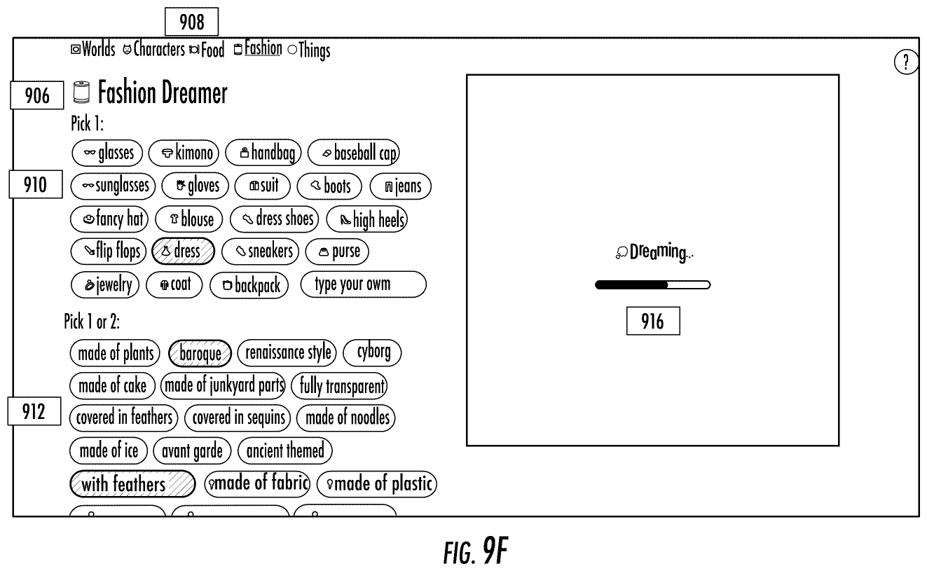

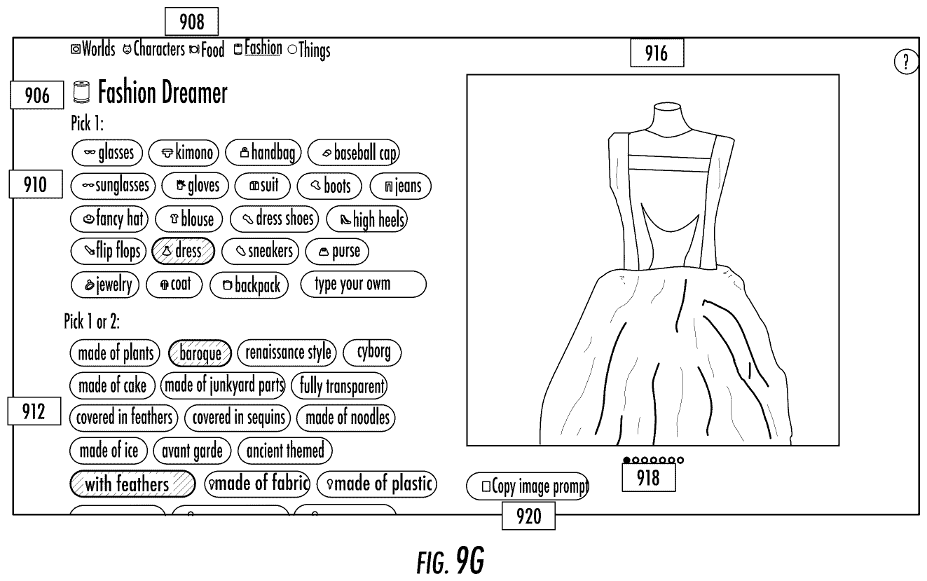

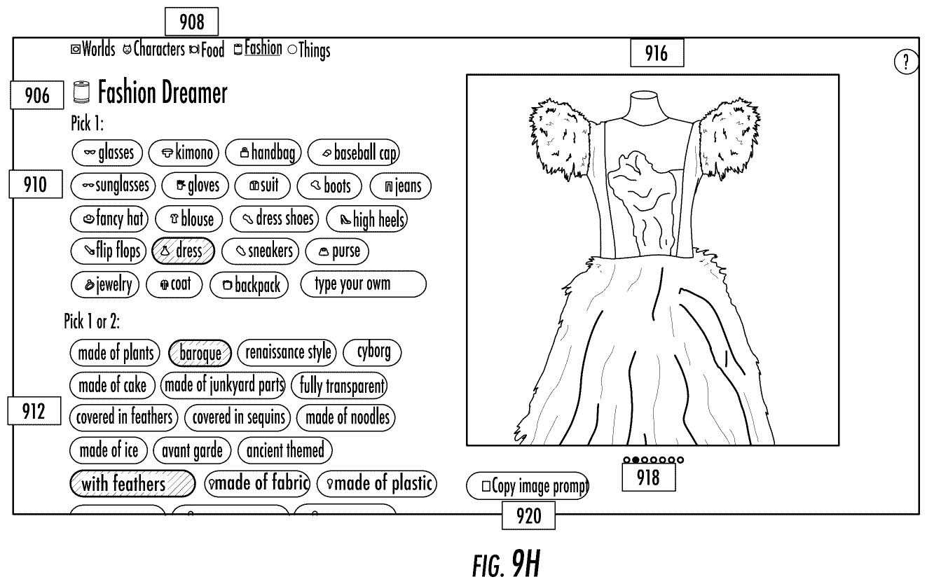

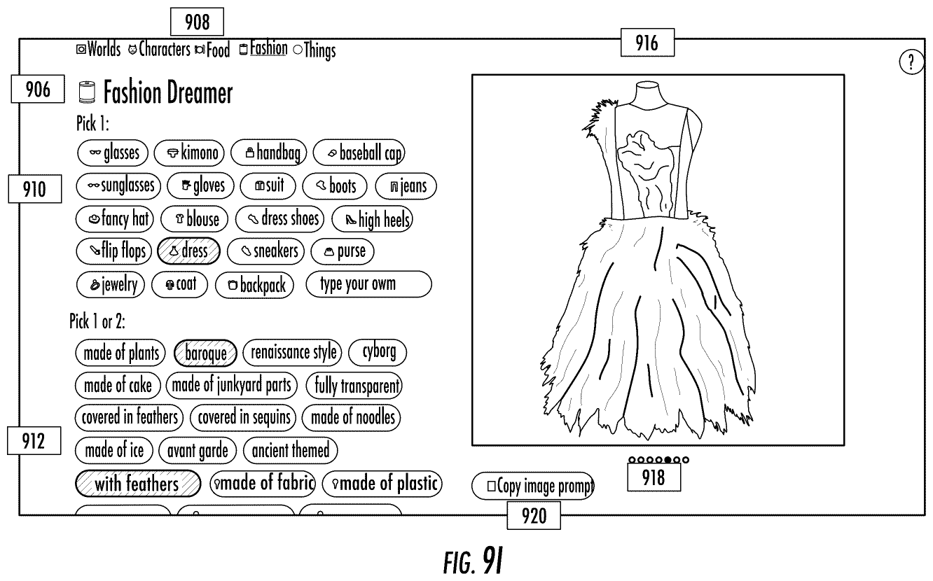

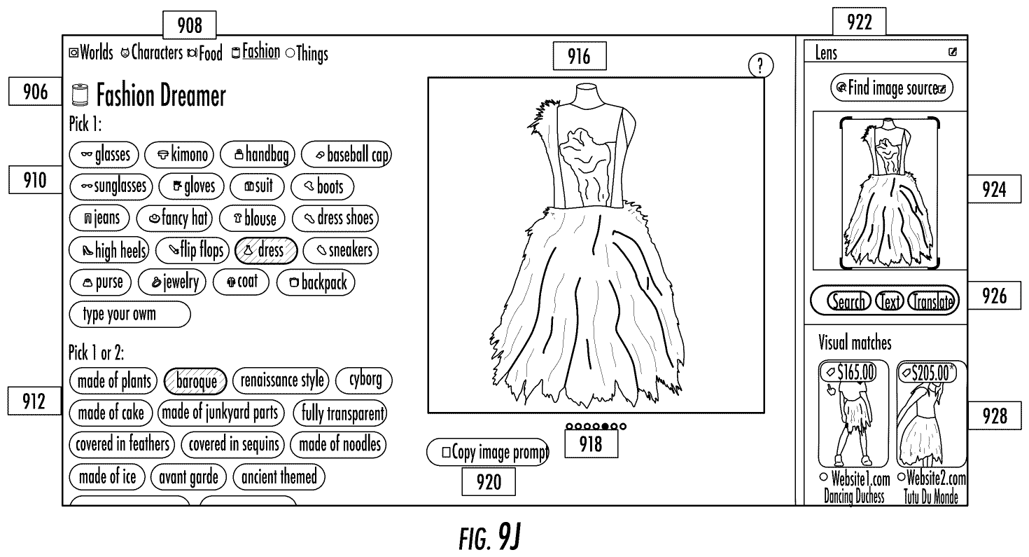

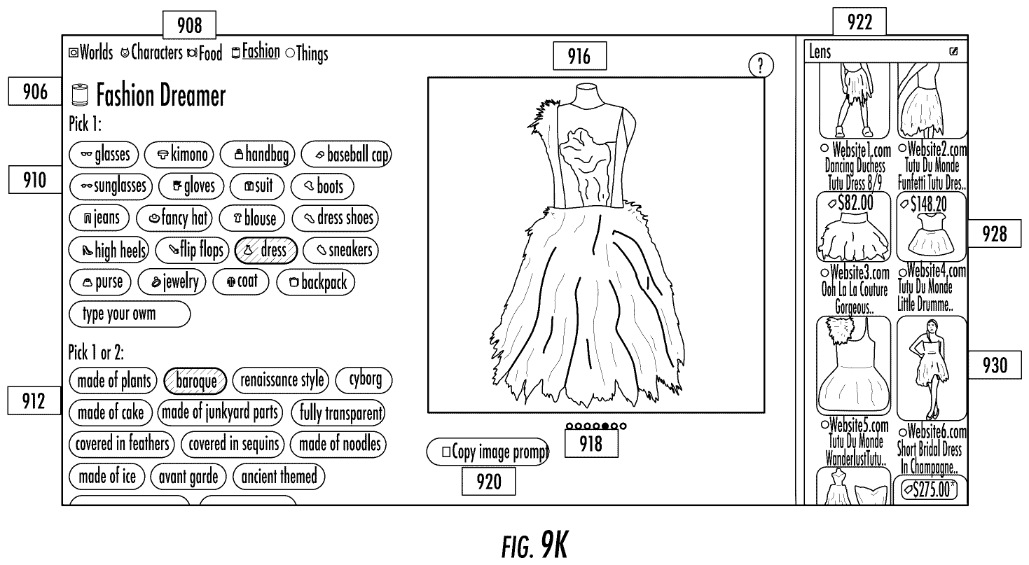

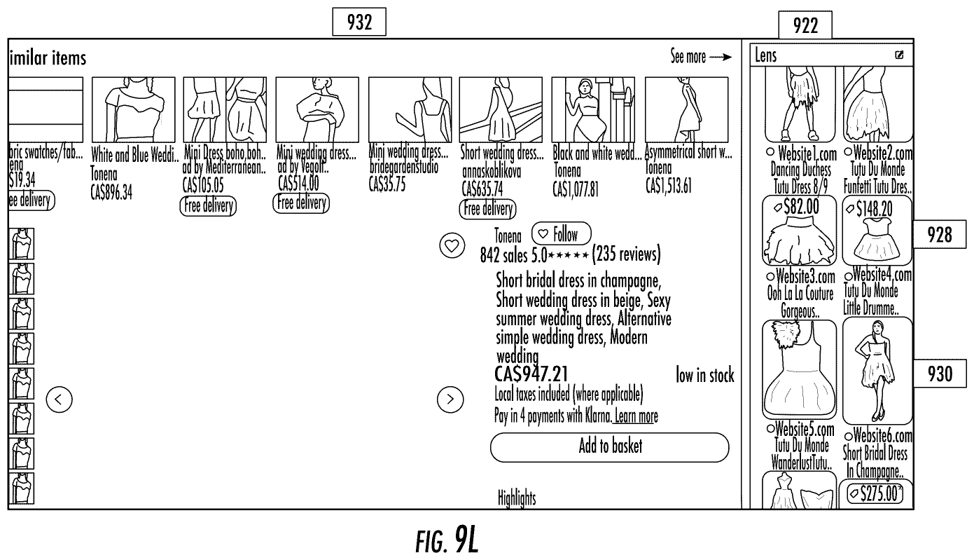

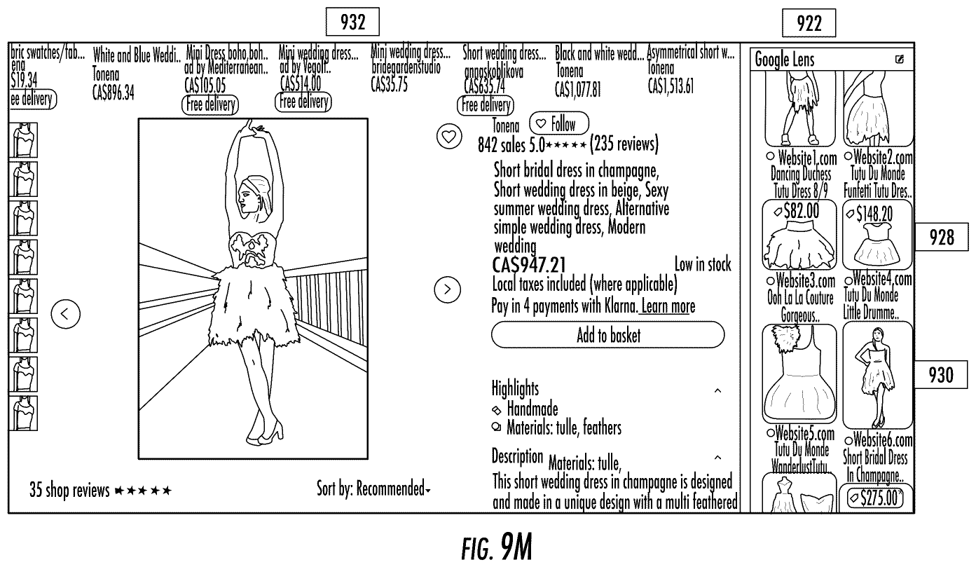

FIG. 9A-9M depict illustrations of an example search interface 900 according to example embodiments of the present disclosure. In particular, FIG. 9A can depict an example initial interface appearance with a freeform text input box 902 and an interactive prompt generation element 904. The interactive prompt generation element 904 can be selected to update the search interface 900 to include a plurality of interactive user interface elements for generating a prompt input.

FIG. 9B depicts the updated interface with a category indicator 906 indicating the selected category for creation, a plurality of category user interface elements 908 for selection to select the particular category for generation, a plurality of first descriptor user interface elements 910, a plurality of second descriptor user interface elements 912, a generate user interface element 914 to initiate the dataset generation, and a preview window 916 for previewing the model-generated datasets.

In response to a selection of a different category user interface element of the plurality of category user interface elements 908, the search interface 900 can be updated again to update the category indicator 906 to indicate the updated selected category (e.g., as shown in FIG. 9C). Additionally and/or alternatively, the plurality of first descriptor user interface elements 910 and the plurality of second user interface elements 912 can be updated. The descriptor user interface elements can be updated based on the particular selected category to include object/environment types and/or adjectives associated with that particular selected category.

In FIG. 9D, the category is “Fashion Designer”, which is associated with “imagining” clothing items. FIG. 9D depicts a first descriptor (i.e., a dress descriptor) of the plurality of first descriptors 910 being selected. Therefore, the user is generating a request to generate an image with a dress. Alternatively and/or additionally, a “Travel Planner”, a “Restaurant Determination”, and/or other location based generation and search.

In FIG. 9E, the selected first descriptor is provided with an indication of selection. Additionally, a particular second descriptor user interface element (i.e., a user interface element with the text “baroque”) of the plurality of second descriptor user interface elements 912 is depicted as being selected.

In FIG. 9F, freeform text (i.e., “with feathers”) is added in an input box, and the generated user interface element 914 is selected, which initiates the generation and a buffer indicator is provided for display in the preview window 916. The buffer indicator can indicate the prompt input is being generated and/or processed with an image generation model to generate a plurality of model-generated images.

In FIG. 9G, the search interface 900 is updated to provide a model-generated image carousel 918 with a first model-generated image provided for display in the preview window 916. The updated search interface can include a copy image prompt interface element 920 that can be selected to utilize the currently previewed image as a query image for a search. The first model-generated image can be descriptive of an image generated based on the category “Fashion Designer”, the first descriptor “dress”, the second descriptor “baroque”, and the freeform text input “with feathers”. A user can then navigate through the model-generated image carousel 918 to view the different model-generated images in the preview window 916. When a user decides a particular model-generated image to utilize as a query, the user can select the copy image prompt interface element 920.

In FIG. 9H, a second model-generated image is provided for display in the preview window 916. In FIG. 9I, a fourth model-generated image is provided for display in the preview window 916. The user can then select the copy image prompt interface element 920. The selection input can be received, and the selected model-generated image can be utilized as an image query to query one or more databases.

In FIG. 9J, a search results panel 922 can be provided for display in response to the receiving the selection input. In some implementations, a cropping interface 924 can be provided to enable the cropping of the selected model-generated image to refine the search results and/or to augment the search query. Other interface options 926 may be provided to navigate between a search option, an optical character recognition option, and a translate option. The search results panel 922 can include a plurality of search results 928 provided for display in response to the model-generated image query. The plurality of search results 928 can be determined based on an association with an image that is determined to be above a similarity threshold.

A user can scroll through the plurality of search results 928 in the search results panel 922 to determine a specific search result 930 of interest (e.g., as shown in FIG. 9K). A selection input can be received that is descriptive of a selection of the specific search result 930. The image generation interface can then be replaced with a browser window 932 that displays at least a portion of a resource associated with the specific search result 930 (e.g., as shown in FIG. 9L). A user can then interact with the web resource in the browser window 932 (e.g., as shown in FIG. 9M). For example, a user may purchase a dress in the browser window 932, in which the purchased dress resembles the dress depicted in the selected model-generated image.

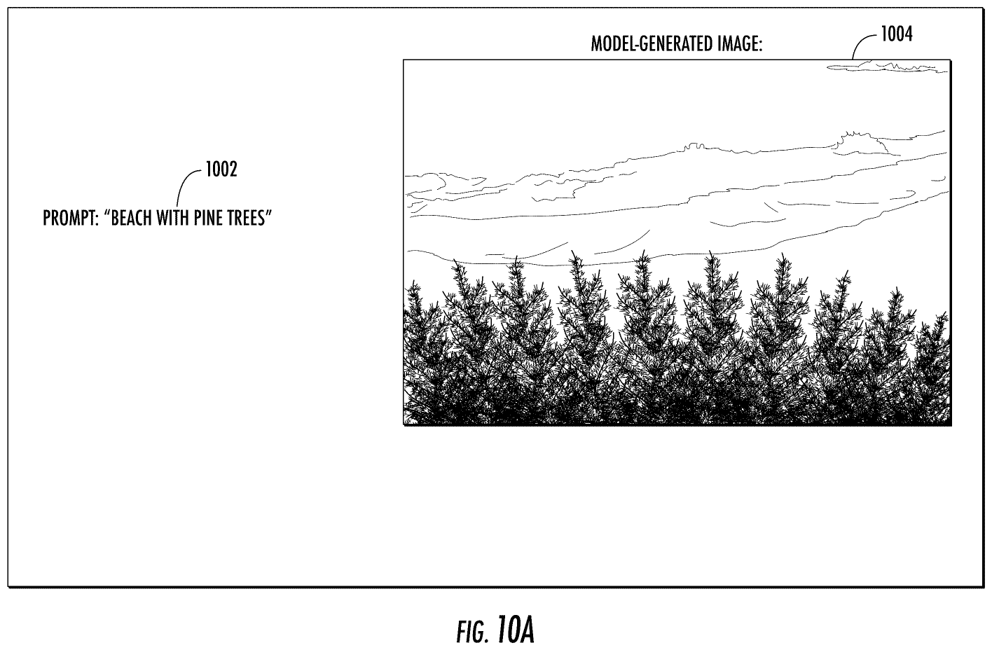

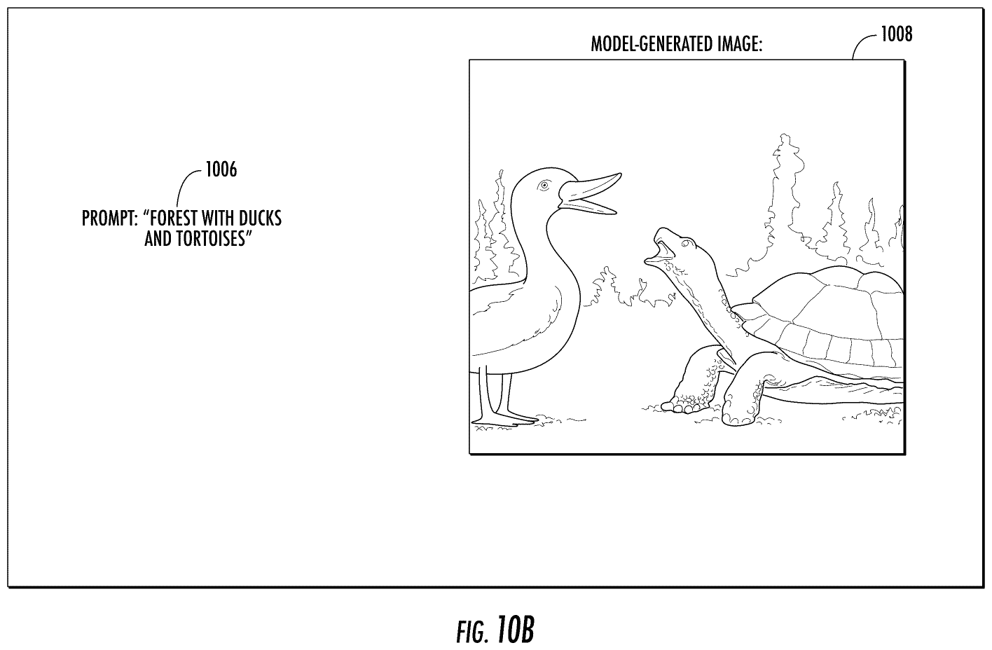

FIG. 10A-10B depict illustrations of example prompt-image pairs according to example embodiments of the present disclosure. In particular, the prompt 1002 in FIG. 10A may be processed with an image generation model to generate the model-generated image 1004, which may then be searched to find real world examples of a beach with pine trees that appears similar to the model-generated image 1004. In FIG. 10B, the prompt 1006 may be processed with an image generation model to generate the model-generated image 1008, which may then be searched to find real world examples of a forest that has ducks and tortoises that appears similar to the model-generated image 1008.

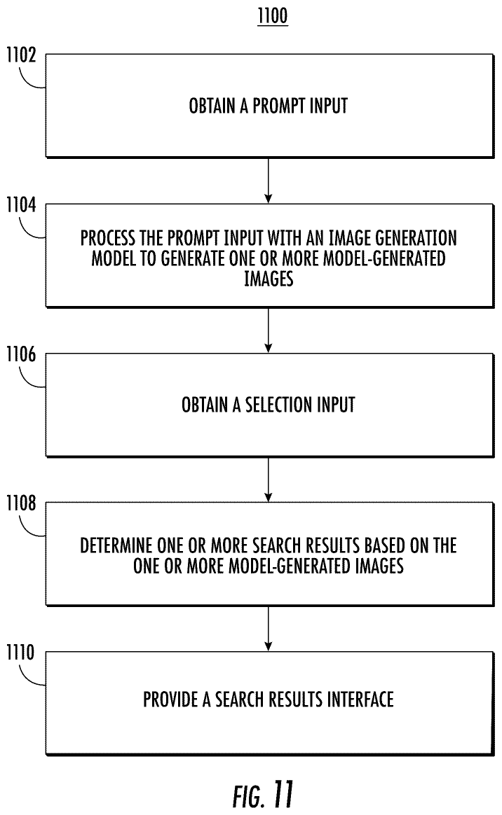

FIG. 11 depicts a flow chart diagram of an example method to perform according to example embodiments of the present disclosure. Although FIG. 11 depicts steps performed in a particular order for purposes of illustration and discussion, the methods of the present disclosure are not limited to the particularly illustrated order or arrangement. The various steps of the method 1100 can be omitted, rearranged, combined, and/or adapted in various ways without deviating from the scope of the present disclosure.

At 1102, a computing system can obtain a prompt input. The prompt input can include one or more terms (e.g., one or more words that can be descriptive of a requested instance interpolation (e.g., “jacket, feathered, brown, regal” to request a view rendering of a brown feathered jacket with a regal aesthetic). In some implementations, the prompt input can include selection data descriptive of one or more selection inputs associated with one or more selectable user-interface elements and/or one or more textual inputs including text input into a text entry box. The prompt input may include one or more terms descriptive of an absence of a particular detail. The one or more terms descriptive of an absence of a particular detail may be associated with a request to generate an image without the particular detail. The particular detail may include an environment, a plant, a structure, an object, a type of material, a color, a style, an attribute, a shape, and/or other feature.

In some implementations, obtaining the prompt input can include providing a plurality of selectable user-interface elements for display in graphical user interface. The plurality of selectable user-interface elements can be associated with a plurality of candidate prompt terms (e.g., environment types, structure types, fauna types, flora types, object types, categories, descriptors for a scene or object, and/or an aesthetic). Selection data can then be obtained. The selection data can be descriptive of a first selectable user-interface element (e.g., a first interactive chip) and a second selectable user-interface element (e.g., a second interactive chip). The first selectable user-interface element can be associated with a first prompt term (e.g., a noun, a verb, an adjective, and/or an adverb associated with a requested concept), and the second selectable user-interface element is associated with a second prompt term (e.g., a noun, a verb, an adjective, and/or an adverb associated with a requested concept). For example, the prompt input can include the first prompt term and the second prompt term associated with the selected first user-interface element and the selected second user-interface element. The prompt terms can be descriptive of a topic (e.g., landscape, amusement park, dress, and/or purse), a quality (e.g., Tron-like, sci-fi, made of plants, a specific video game aesthetic, baroque, cyborg, and/or covered in sequins), and/or an action (e.g., dancing, running, playing football, and/or cheering).

In some implementations, the plurality of selectable user-interface elements can be provided for display in response to obtaining a prompt selection request. The prompt selection request can be descriptive of an input to receive the graphical user interface of selectable user-interface chips. The prompt selection request may be received by a user computing system during the display of an entry point interface that includes a text input box for receiving user input data to generate machine-learned model outputs based on a user provided text prompt. The plurality of candidate prompt terms associated with the plurality of selectable user-interface chips may be predetermined. The first prompt term can be associated with a type of object. The second prompt term can be associated with a particular descriptive feature, and the one or more model-generated images may be descriptive of a particular object of the type of object with the particular descriptive feature.

In some implementations, the prompt input may include a multi-modal prompt input. The multi-modal prompt input can include a prompt image and prompt text. The prompt image can be descriptive of a particular object and/or a particular environment with one or more particular details. In some implementations, the prompt input may be an image search result selected by a user to augment for a refined search. The image search result may be provided with a plurality of other search results in response to obtaining a search query (e.g., a text query, an image query, and/or a multi-modal query). Alternatively and/or additionally, the prompt image may include a user image and/or a previously generated model-generated image. The prompt text can be descriptive of one or more particular details of the prompt image to augment. For example, the prompt text can be descriptive of a request to render the particular object and/or the particular environment without the one or more particular details. The one or more particular details may be replaced with one or more other details and/or replaced with predicted background pixels. In some implementations, the prompt text can be descriptive of a request to include additional details (e.g., additional objects, additional colors, additional shapes, and/or additional materials).

At 1104, the computing system can process the prompt input with an image generation model to generate one or more model-generated images. The one or more model-generated images can be generated based at least in part on the one or more terms. The image generation model can be trained on a plurality of training images. The image generation model may be trained on a particular topic and/or a particular object type (e.g., a particular article of clothing). Alternatively and/or additionally, the image generation model can be trained generally. The training may include label training, and the labels can be utilized to determine and/or to generate the selectable user interface elements. For example, a particular label can be associated with a plurality of images (e.g., a “shirt” label can be associated with images for a plurality of different shirts and/or a “furry” label can be associated with a plurality of images associated with a plurality of fur for articles of clothing and/or interiors). The descriptor of the label can then be utilized to generate a selectable user interface element for the descriptor to be utilized as a prompt term. The one or more model-generated images may be descriptive of a generated environment and/or a generated object without the particular detail. For example, the prompt input can include terms descriptive of a request for a particular object (e.g., a dress) without a particular detail (e.g., a ribbon and/or buttons), and the image-generation model can process the prompt input to generate an image of the object without the particular detail (e.g., a dress without ribbons and/or buttons).

In some implementations, the one or more model-generated images can be provided for display with the one or more terms in a graphical user interface. For example, a plurality of model-generated images can be generated and provided for display in an image carousel. The one or more model-generated images can be provided for display for interaction. A user may select a portion of a particular model-generated image to augment. For example, a user may be able to remove features (e.g., remove an object from a scene, remove an accessory, and/or tailor an article of clothing), change features (e.g., change a texture and/or change a color), and/or add features (e.g., add an object, add an ascent, and/or add an accessory) by providing one or more augmentation inputs.

In some multi-modal prompt input implementations, prompt image and the prompt text can be processed with the image generation model to generate a model-generated image. The model-generated image can be descriptive of a model-generated object. The model-generated object can be descriptive of the particular object augmented based on the prompt text. In some implementations, the model-generated image can be descriptive of the particular object without the one or more particular details.

At 1106, the computing system can obtain a selection input. The selection input can be descriptive of a selection of the one or more model-generated images. The selection input can be descriptive of a request to query one or more databases for content and/or an item that is similar to the content in and/or an item in the selected model-generated image. The selection input may include one or more selections of one or more portions of the selected model-generated image that are of interest. The one or more portions may be segmented (or cropped) to then be input into a search engine.

At 1108, the computing system can determine one or more search results based on the one or more model-generated images. The one or more search results can be associated with one or more objects. In some implementations, the one or more search results can be associated with one or more products. Additionally and/or alternatively, the one or more search results can include one or more action links associated with the one or more products. The one or more action links can be associated with a purchase interface for the one or more products. The one or more search results can be determined based on one or more labels associated with the model-generated image. Alternatively and/or additionally, the model-generated image can be processed with an embedding model to generate an embedding. The embedding can then be utilized to determine similar embeddings, which can be associated with the one or more search results. The one or more prompt terms may be utilized to determine the one or more search results. For example, the one or more search results can be obtained by generating a combined query with the prompt terms and the model-generated image.

In some implementations, determining the one or more search results based on the one or more model-generated images can include providing the one or more model-generated images to a search engine and receiving the one or more search results from the search engine. The search engine can be a general search engine and/or may be a database-specific search engine (e.g., a shopping search engine).

At 1110, the computing system can provide a search results interface. The search results interface may include the one or more search results provided for display. The search results interface can be a search results page. The search results interface can include a list of search results, an augmented-reality try-on interface, and/or a viewport for viewing previews of resources associated with one or more search results.

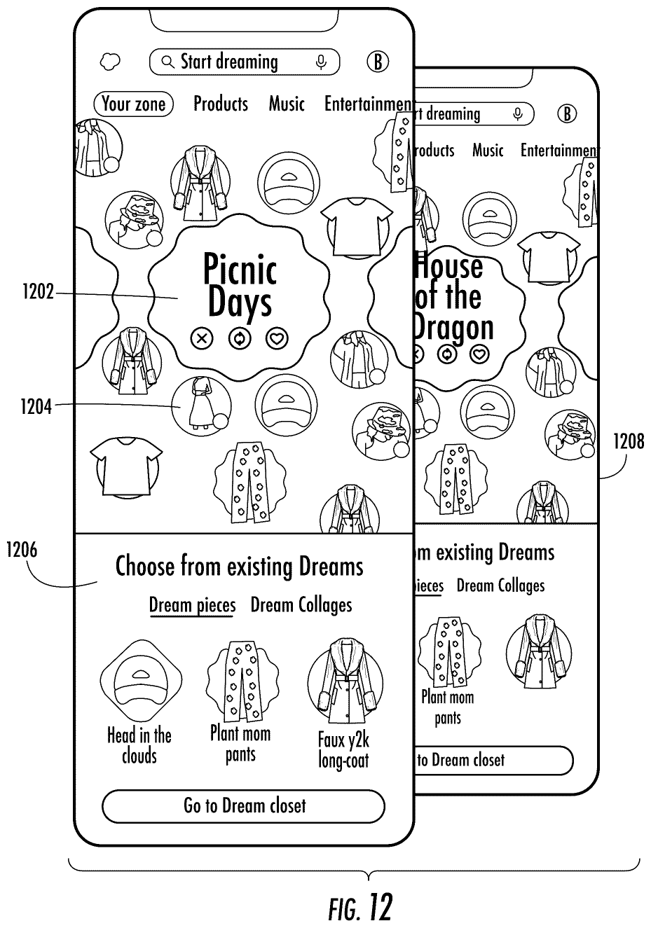

FIG. 12 depicts an illustration of an example collections interface according to example embodiments of the present disclosure. In particular, a user may generate and label collections. For example, a user can generate a “Picnic Days” collection, which can include a title label 1202, a plurality of saved images 1204 (e.g., a plurality of model-generated images), and a panel for selecting additional datasets (e.g., suggested model-generated datasets) to add to the collection. In some implementations, a collection may be automatically generated. For example, a collection associated with a determined liked content item can be generated 1208.

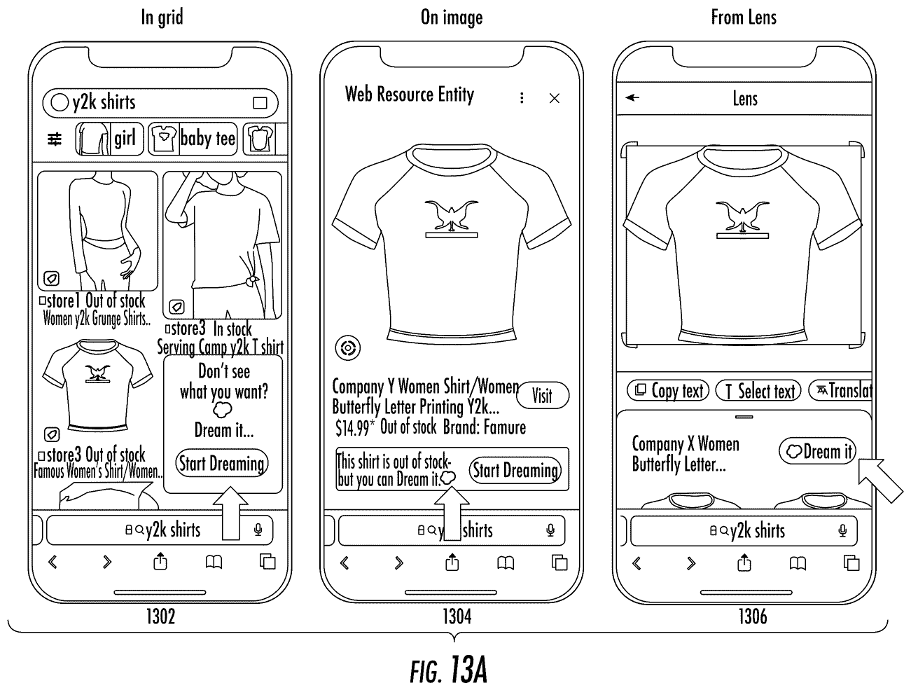

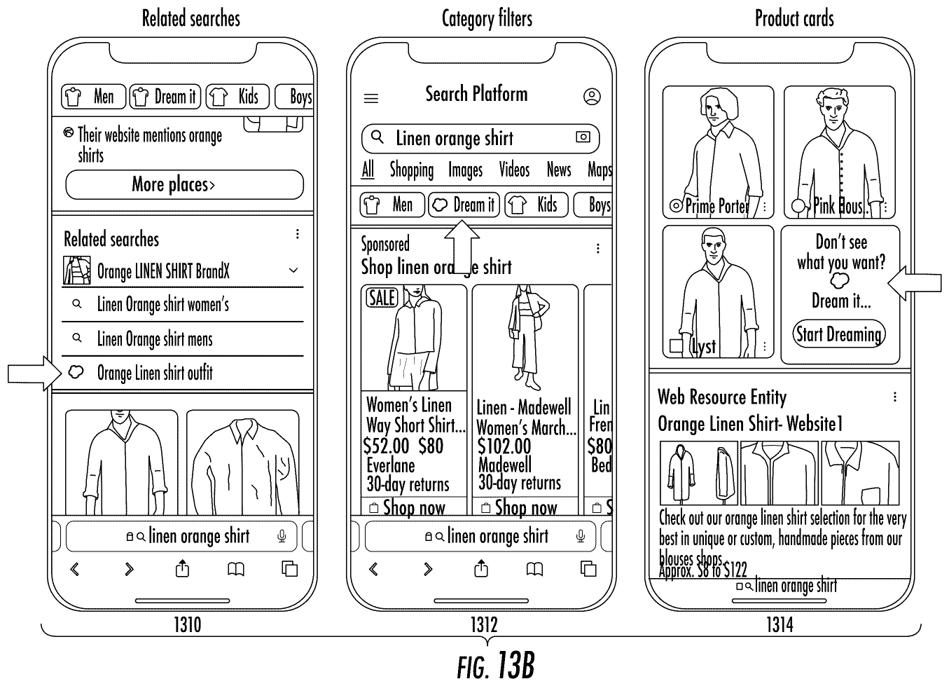

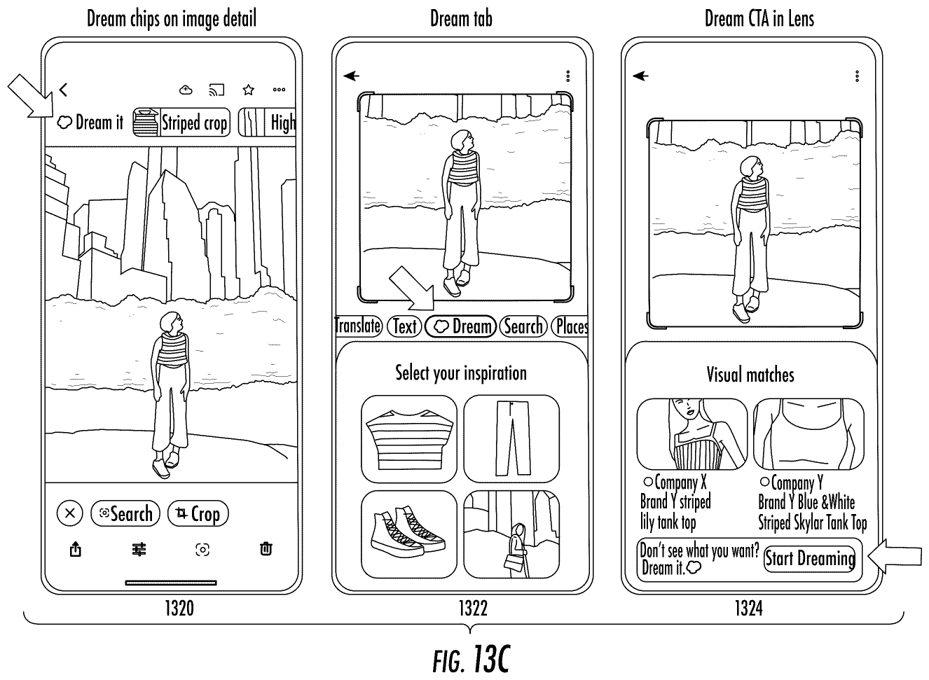

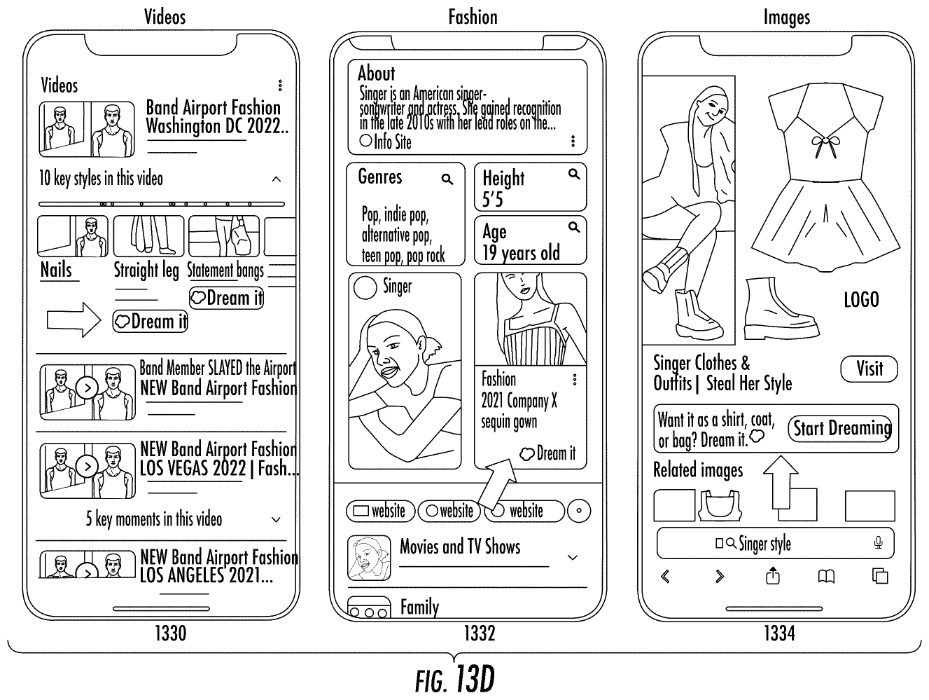

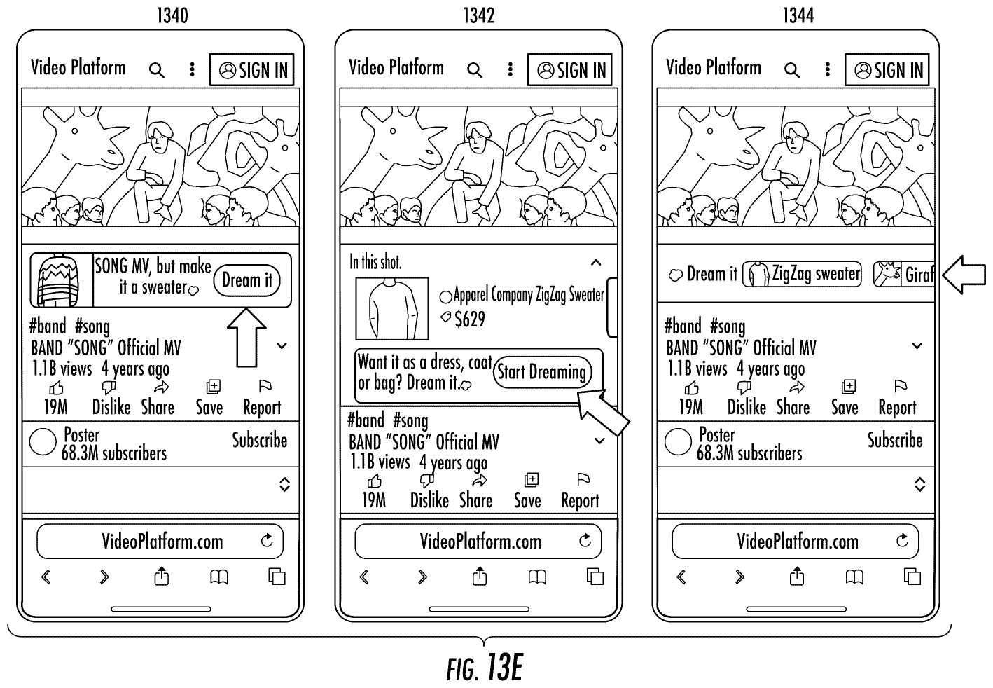

FIG. 13A-13E depict illustrations of example search interface entry points according to example embodiments of the present disclosure.

In particular, FIG. 13A includes a plurality of entry points in search interfaces. For example, a “start dreaming” tile can be provided for display adjacent to image search results in a grid 1302. A “start dreaming” chip may be provided for display below an image search result in an enlarged image viewer 1304. Additionally and/or alternatively, a “dream it” chip interface element can be provided in a search results pane of an image recognition interface 1306. The “start dreaming” tile, the “start dreaming” chip, and/or the “dream it” chip interface element can be interacted with to begin the prompt generation and image generation process.

FIG. 13B depicts example entry points for prompt generation and image generation displayed in general search results pages. For example, the entry point interface element can be provided in a related searches section 1310, in a refined search tile carousel 1312, and/or in a tile of an image search results panel 1314.

FIG. 13C depicts example entry points for prompt generation and image generation displayed in viewfinder and recognition application. For example, the entry point interface element can be provided in a chips carousel adjacent to recognized object chips 1320, in a category functions tab carousel 1322, and/or in a search results pop-up 1324.

FIG. 13D depicts example entry points for prompt generation and image generation displayed in varying search result types. For example, in a video search results page 1330, the entry point interface element may be provided below segment identifiers of a video search result. In a fashion search results page 1332, the entry point interface element can be provided with a specific search result to utilize the specific search result in the prompt generation. Additionally and/or alternatively, in an image search results page 1334, the entry point interface element can be provided with a specific search result to utilize the specific search result in the prompt generation.

FIG. 13E depicts example entry points for prompt generation and image generation displayed in a video player application. The entry point interface element can be provided below a playing video with a randomized model-generated image 1340, below a search result based on a recognized object in the video 1342, and/or in a chip carousel adjacent to recognized object chips 1344.

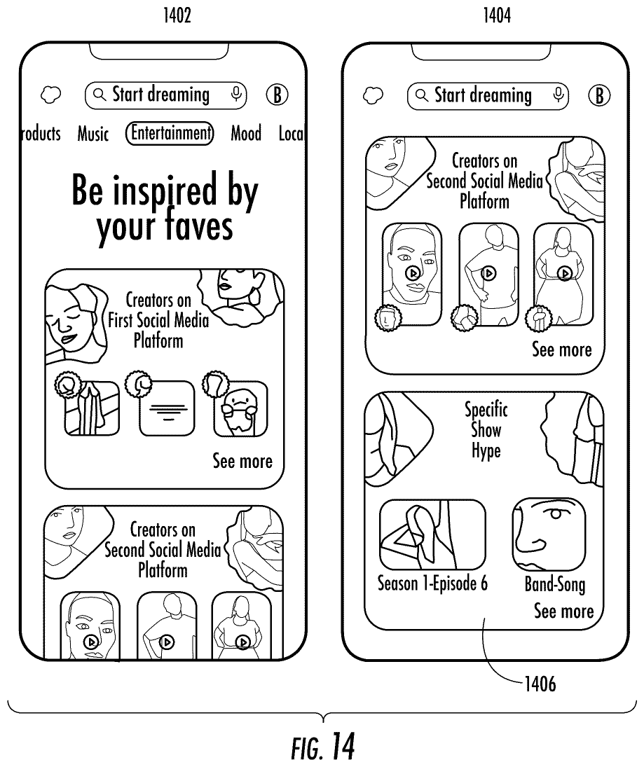

FIG. 14 depicts an illustration of an example collections interface according to example embodiments of the present disclosure. The collections interface can include an entertainment tab 1402, which can include saved entertainment collections and/or suggested entertainment collections. A user can scroll through the entertainment tab to a lower portion 1404, which may include social media platform specific collections and/or show specific collections 1406.

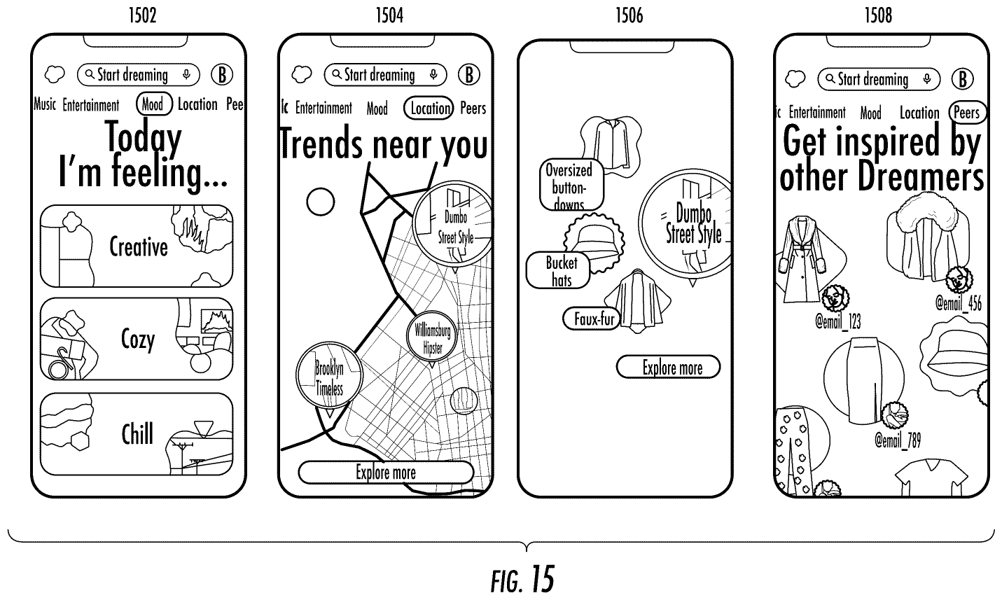

FIG. 15 depicts illustrations of example suggestion interfaces according to example embodiments of the present disclosure. In particular, in 1502, a mood tab is provided for display in which a user can receive suggestions based on a mood, which can include “creative,” “cozy,” and “chill.” The suggestions may be tailored based on user data and the selected mood. In 1504, a location tab is provided for display with a plurality of indicators associated with different locations, which can include an initial aesthetic image associated with the location. At 1506, a user may have selected the dumbo street style indicator, and a plurality of suggested clothing items are provided for display. The suggested clothing items can be model-generated images of articles of clothing that are based on the aesthetic and/or clothing style of the location with one or more user-specific preferences, which may be manually input preferences and/or machine-learned preferences based on a user's purchases, closet, browsing history, and/or search history. At 1508, a peers tab is provided for display, which can include products, objects, and/or model-generated images that a “peer” (e.g., a social media friend and/or a person with similar profile data (e.g., similar location, similar clothing taste, and/or similar hobbies) has added to their specific virtual collection).

Querying the one or more databases with the one or more particular model-generated datasets can include processing the one or more particular model-generated datasets with one or more machine-learned models (e.g., one or more classification models and/or one or more embedding models). For example, the one or more particular model-generated datasets can be processed by one or more embedding models to generate one or more features, which can then be utilized to query for a database for associated embeddings (e.g., one or more embedding neighbors) which may be associated with one or more candidate search results. Alternatively and/or additionally, the one or more particular model-generated datasets can be processed by one or more classification models to determine one or more classification tags that can be utilized to generate a query to query one or more databases.

In particular, articulating concepts and ideas for search can be difficult and some concepts cannot be specifically articulated, which can lead to issues in search result scope. Additional problems can include not knowing what terms to use, wanting unique content, vocabulary boundaries between user and an industry, only partial results, and/or off-topic search results.

The systems and methods disclosed herein can leverage one or more machine-learned diffusion models to generate images that can encapsulate a user request and can then be utilized as an image query to determine real world objects that are similar to the “imagined” objects of the model-generated image. Artificial intelligence (AI) generation models can be utilized to generate images that can be reviewed and selected to be utilized as a search query. In particular, images can provide a more detailed context of what a user is requesting during the search, which can allow for a more tailored search than text alone.

The present disclosure is directed to systems and methods for searching with a machine-learned model-generated data query. In particular, the systems and methods disclosed herein can leverage one or more machine-learned models and one or more user-interface elements to provide an interactive graphical user interface for suggesting, generating, and/or refining search queries based on model-generated datasets. Generated images can therefore be utilized to provide accurate search results as the generated dataset can provide a more detailed jumping off point for search. For example, the systems and methods can include obtaining a prompt input. The prompt input can include one or more terms. The prompt input can be processed with an image generation model to generate one or more model-generated images. The one or more model-generated images can be generated based at least in part on the one or more terms. A selection input can then be obtained. The selection input can be descriptive of a selection of the one or more model-generated images. The systems and methods can include determining one or more search results based on the one or more model-generated images. The one or more search results can be associated with one or more objects (e.g., a product such as an article of clothing). A search results interface can be provided for display (e.g., a search results page). The search results interface can provide the one or more search results for display and may include a viewport for viewing a search results list and at least a portion of a resource associated with one or more search results.

The systems and methods disclosed herein can be utilized to provide an interface for generating suggested datasets, that can then be utilized to query the web for pre-existing datasets that may be similar to and/or are associated with the model-generated dataset. For example, the model-generated dataset can include a model-generated image that is descriptive of instance interpolation of an object. The model-generated object can then be utilized to query one or more databases to identify a resource associated with an object that is similar to the object depicted in the model-generated image.

The systems and methods can obtain a prompt input (e.g., selection data descriptive of one or more selections received from a user computing device). The prompt input can include one or more terms (e.g., one or more words that can be descriptive of a requested instance interpolation (e.g., “jacket, feathered, brown, regal” to request a view rendering of a brown feathered jacket with a regal aesthetic). In some implementations, the prompt input can include selection data descriptive of one or more selection inputs associated with one or more selectable user-interface elements and/or one or more textual inputs including text input into a text entry box.

In some implementations, obtaining the prompt input can include providing a plurality of selectable user-interface elements for display in graphical user interface. The plurality of selectable user-interface elements can be associated with a plurality of candidate prompt terms (e.g., object types, categories, descriptors for a scene or object, and/or an aesthetic). Selection data can then be obtained. The selection data can be descriptive of a first selectable user-interface element (e.g., a first interactive chip) and a second selectable user-interface element (e.g., a second interactive chip). The first selectable user-interface element can be associated with a first prompt term (e.g., a noun, a verb, an adjective, and/or an adverb associated with a requested concept), and wherein the second selectable user-interface element is associated with a second prompt term (e.g., a noun, a verb, an adjective, and/or an adverb associated with a requested concept). For example, the prompt input can include the first prompt term and the second prompt term associated with the selected first user-interface element and the selected second user-interface element. The prompt terms can be descriptive of a topic (e.g., landscape, amusement park, dress, and/or purse), a quality (e.g., Tron-like, sci-fi, made of plants, a specific video game aesthetic, baroque, cyborg, and/or covered in sequins), and/or an action (e.g., dancing, running, playing football, and/or cheering).

In some implementations, the plurality of selectable user-interface elements can be provided for display in response to obtaining a prompt selection request. The prompt selection request can be descriptive of an input to receive the graphical user interface of selectable user-interface chips. The prompt selection request may be received by a user computing system during the display of an entry point interface that includes a text input box for receiving user input data to generate machine-learned model outputs based on a user provided text prompt. The plurality of candidate prompt terms associated with the plurality of selectable user-interface chips may be predetermined. The first prompt term can be associated with a type of object. The second prompt term can be associated with a particular descriptive feature, and the one or more model-generated images may be descriptive of a particular object of the type of object with the particular descriptive feature.

The prompt input can be processed with an image generation model to generate one or more model-generated images. The one or more model-generated images can be generated based at least in part on the one or more terms. The image generation model can be trained on a plurality of training images. The image generation model may be trained on a particular topic and/or a particular object type (e.g., a particular article of clothing). Alternatively and/or additionally, the image generation model can be trained generally. The training may include label training, and the labels can be utilized to determine and/or to generate the selectable user interface elements. For example, a particular label can be associated with a plurality of images (e.g., a “shirt” label can be associated with images for a plurality of different shirts and/or a “furry” label can be associated with a plurality of images associated with a plurality of fur for articles of clothing and/or interiors). The descriptor of the label can then be utilized to generate a selectable user interface element for the descriptor to be utilized as a prompt term.

In some implementations, the one or more model-generated images can be provided for display with the one or more terms in a graphical user interface. For example, a plurality of model-generated images can be generated and provided for display in an image carousel. The one or more model-generated images can be provided for display for interaction. A user may select a portion of a particular model-generated image to augment. For example, a user may be able to remove features (e.g., remove an object from a scene, remove an accessory, and/or tailor an article of clothing), change features (e.g., change a texture and/or change a color), and/or add features (e.g., add an object, add an ascent, and/or add an accessory) by providing one or more augmentation inputs.

A selection input can then be obtained. The selection input can be descriptive of a selection of the one or more model-generated images. The selection input can be descriptive of a request to query one or more databases for content and/or an item that is similar to the content in and/or an item in the selected model-generated image. The selection input may include one or more selections of one or more portions of the selected model-generated image that are of interest. The one or more portions may be segmented (or cropped) to then be input into a search engine.

The systems and methods can determine one or more search results based on the one or more model-generated images. The one or more search results can be associated with one or more objects. In some implementations, the one or more search results can be associated with one or more products. Additionally and/or alternatively, the one or more search results can include one or more action links associated with the one or more products. The one or more action links can be associated with a purchase interface for the one or more products. The one or more search results can be determined based on one or more labels associated with the model-generated image. Alternatively and/or additionally, the model-generated image can be processed with an embedding model to generate an embedding. The embedding can then be utilized to determine similar embeddings, which can be associated with the one or more search results. The one or more prompt terms may be utilized to determine the one or more search results. For example, the one or more search results can be obtained by generating a combined query with the prompt terms and the model-generated image.

In some implementations, determining the one or more search results based on the one or more model-generated images can include providing the one or more model-generated images to a search engine and receiving the one or more search results from the search engine. The search engine can be a general search engine and/or may be a database-specific search engine (e.g., a shopping search engine).

A search results interface can then be provided for display. The search results interface may include the one or more search results provided for display. The search results interface can be a search results page. The search results interface can include a list of search results, an augmented-reality try-on interface, and/or a viewport for viewing previews of resources associated with one or more search results.

The systems and methods can be utilized for finding images and products similar to request. Additionally and/or alternatively, the systems and methods disclosed herein can be utilized to find other data types (e.g., a song that fits an aesthetic and/or theme). For example, a machine-learned model can be trained to generate audio data based on one or more prompt inputs (e.g., “jazz, upbeat, saxophone solo” can be input to the machine-learned model to generate synthetic song, which can be presented to a user for selection then search.). For example, the systems and methods can include obtaining a prompt input. The prompt input can include one or more terms. The prompt input can be processed with a data generation model to generate a plurality of model-generated datasets. The plurality of model-generated datasets can be generated based at least in part on the one or more terms. The systems and methods can include providing the plurality of model-generated datasets via a user interface and obtaining a selection input. The selection input can be descriptive of a selection of a particular model-generated dataset of the plurality of model-generated datasets. The systems and methods can include determining one or more search results based on the particular model-generated dataset and providing the one or more search results as an output.

The systems and methods can obtain a prompt input. The prompt input can include one or more terms. The prompt input can be generated based on one or more selections of one or more user interface chips that can include text characters and/or icons associated with terms to utilize to prompt a data generation model. In some implementations, the prompt input can include one or more images, one or more audio clips, and/or latent encoding data.

The prompt input can be processed with a data generation model to generate a plurality of model-generated datasets. The plurality of model-generated datasets can be generated based at least in part on the one or more terms. In some implementations, each of the plurality of model-generated datasets may differ. The data generation model can be trained to generate one or more datasets based on a plurality of learned parameters and conditioned based on the prompt input. The model-generated dataset can include image data, audio data, multimodal data, text data, latent encoding data, and/or sensor data. For example, the plurality of model-generated datasets can include a plurality of images (e.g., a plurality of predicted depictions descriptive of the prompt input), a plurality of audio clips (e.g., a plurality of generated song clips predicted to be descriptive of the prompt input), and/or a plurality of video datasets (e.g., a plurality of predicted video clips generated based on the prompt input).

The plurality of model-generated datasets can then be provided for display via a user interface. Providing the plurality of model-generated datasets via the user interface can include providing a plurality of model-generated images in an image carousel. The plurality of model-generated datasets can be provided as a list of links to preview the model-generated datasets. Alternatively and/or additionally, the plurality of model-generated datasets can be transmitted for local download.

The systems and methods can then obtain a selection input. The selection input can be descriptive of a selection of a particular model-generated dataset of the plurality of model-generated datasets. For example, the user may navigate through a carousel of model-generated datasets, can determine a specific model-generated dataset of interest, and the user can then select the specific model-generated dataset to be utilized to query a database.

In some implementations, obtaining the selection input can include obtaining the selection of the particular model-generated dataset of the plurality of model-generated datasets and obtaining a cropping input. The cropping input can be descriptive of a portion of the particular model-generated dataset. The portion of the particular model-generated dataset can be segmented to generate a cropped model-generated dataset. In some implementations, the one or more search results can be determined based on the cropped model-generated dataset.

The systems and methods can determine one or more search results based on the particular model-generated dataset. The one or more search results can be determined based on an association with a resource dataset that is determined to be similar to the selected model-generated dataset. For example, a resource dataset can be a song determined to be similar to the model-generated audio clip.

The one or more search results can then be provided as an output. The one or more search results can be provided in a search results page. In some implementations, the one or more search results can be provided adjacent to one or more model-generated datasets. For example, the one or more search results can be provided in a panel of the user interface, and the one or more model-generated datasets can be provided in a same panel and/or a different panel.

The systems and methods disclosed herein can utilize a selection interface to generate the prompt input to be processed for generation. The selection interface can include a plurality of user-interface elements (e.g., chips or tiles) that can include words, symbols, and/or icons that are associated with a plurality of potential prompt terms. For example, the systems and methods can include providing an image-generation interface for display. The image-generation interface can include a plurality of category user-interface elements. Each category user-interface element can be associated with a different generation category. The systems and methods can include obtaining first input data. The first input data can be associated with a selection of a particular category user-interface element of the plurality of category user-interface elements. The particular category user-interface element can be associated with a particular category. The systems and methods can include providing a plurality of descriptor user-interface elements for display in the image-generation interface. Each descriptor user-interface element can be associated with a different descriptor. The systems and methods can include obtaining second input data. The second input data can be associated with a selection of one or more particular descriptor user-interface elements of the plurality of descriptor user-interface elements. In some implementations, the one or more particular descriptor user-interface elements can be associated with one or more particular descriptors. The systems and methods can include processing data associated with the one or more particular descriptors with a machine-learned image-generation model to generate one or more model-generated images and providing the one or more model-generated images for display in the image-generation interface.

The systems and methods can obtain an image-generation interface for display. The image-generation interface can include a plurality of category user-interface elements. In some implementations, each category user-interface element (e.g., a chip, tile, and/or a drop-down element) can be associated with a different generation category (e.g., a scene, a mural, an article of clothing, and/or a video game).

First input data can then be obtained. The first input data can be associated with a selection of a particular category user-interface element of the plurality of category user-interface elements. The particular category user-interface element can be associated with a particular category. In some implementations, the particular category can be associated with clothing. Additionally and/or alternatively, the one or more particular descriptors can be associated with one or more clothing terms descriptive of a clothing item.

A plurality of descriptor user-interface elements (e.g., a chip, a tile, and/or drop-down elements) can be provided for display in the image-generation interface. Each descriptor user-interface element can be associated with a different descriptor (e.g., an adjective and/or a complementary noun or verb associated with the particular category). The descriptors may be general descriptors for a plurality of different categories. Alternatively and/or additionally the plurality of descriptors may be determined and/or provided based on the selected category (e.g., a clothing material and/or a brand may be provided based on a clothing category being selected).

Second input data can then be obtained. The second input data can be associated with a selection of one or more particular descriptor user-interface elements of the plurality of descriptor user-interface elements. The one or more particular descriptor user-interface elements can be associated with one or more particular descriptors. Additionally and/or alternatively, a freeform text input can be obtained. For example, a text input box may be provided for display and can be utilized to receive freeform text associated with one or more additional descriptors.

Data associated with the one or more particular descriptors can be processed with a machine-learned image-generation model to generate one or more model-generated images. In some implementations, a prompt can be generated based on the category selection and the descriptor selection(s). Additionally and/or alternatively, a specific machine-learned image-generation model can be obtained based on the selected category. The prompt may be a structured prompt based on a selection hierarchy (e.g., a category the descriptors and/or based on the time of selection).

The one or more model-generated images can be provided for display in the image-generation interface. The one or more model-generated images can be provided in a carousel interface, in a list, in a grid, and/or a slideshow interface.

In some implementations, the systems and methods can obtain third input data. The third input data can be descriptive of a selection of the one or more model-generated images. The systems and methods can then determine one or more search results based on the one or more model-generated images. The one or more search results can be associated with one or more objects. A search results interface can then be provided for display. The search results interface can provide the one or more search results for display.

Additionally and/or alternatively, edit input data can be obtained. The edit input data can be descriptive of a request to replace one or more first features of the one or more model-generated images with one or more second features. One or more updated model-generated images can then be generated based on the edit input data. The edit input data can be associated with a color change. In some implementations, the edit input data can be associated with a texture change.

The prompt generation interface and/or the dataset generation and search interface may be provided in a search application, a browser application, a shopping application, a viewfinder application, an image recognition application, an augmented-reality application, a virtual-reality application, a discover application (e.g., a suggestion application), an image generation application, and/or in a web application or platform.

The systems and methods can include rerendering options. For example, the user may deselect one or more prompt interface elements and may select additional interface elements, then render a new dataset and/or a new portion of the generated dataset. A user may select a portion of the generated dataset to replace with a portion of another dataset. Additionally and/or alternatively, a user may select a replacement color, a replacement material, a replacement texture, and/or a replacement design.

The generated dataset (e.g., a model-generated image) and/or the one or more search results can be saved. For example, the model-generated image and/or a product associated with a search result may be added to a user-specific library, gallery, virtual closet, and/or collection. Sub-groups and/or sub-collections may be generated based on a color, determined aesthetic, and/or a determined association. The sub-collections and/or sub-groups can include data from other applications (e.g., social media applications). In some implementations, prompts may be suggested based on data from other applications and/or based on the generated collections. For example, media content and/or web content can be saved and/or interacted with, which can then be utilized to generate a suggested prompt.

In some implementations, the systems and methods can be utilized to find real world clothing, preexisting art, and/or potential travel locations. For example, A category can be selected (e.g., clothing, art, and/or a location). A plurality of suggested prompt term user interface elements (or a plurality of descriptor user interface elements) associated with the category can be provided for display. The user can select multiple suggested prompt terms to generate a prompt that can be provided to the image generation model to generate a model-generated image. A user can determine the model-generated image is in line with a desired search. The model-generated image can then be searched to find an article of clothing, an art piece, and/or a travel location that matches the depicted features of the model-generated image.

The systems and methods may be performed based on cloud processing. Alternatively and/or additionally, the processing may be performed locally on a user device and/or via a device at a retailer. The systems and methods may be embedded in a search interface.

The prompts may include a vibe and/or an aesthetic associated with a content item, a time period, a genre, and/or a location. The image generation model may include a text-to-image diffusion model (e.g., the text-to-image diffusion model of Imagen, GOOGLE RESEARCH (Nov. 25, 2022, 3:40 PM), https://imagen.research.google/.). The image generation model can include a transformer model (e.g., a T5-XXL encoder).

The systems and methods can utilize the model-generated image as a query, the prompt input as a query, and/or metadata associated with the user and/or the inputs as a query. For example, the selected model-generated image and the prompt input may be processed by a search engine to determine the one or more search results. The multi-modal search query can include multi-modal embedding, feature recognition and text query generation, image based searching with text based ranking, text based searching and image based ranking, and/or conditioned processing.

Articulating concepts and ideas for search can be difficult and some concepts cannot be specifically articulated, which can lead to issues in search result scope. Additional problems can include not knowing what terms to use, wanting unique content, vocabulary boundaries between user and an industry, only partial results, and/or off-topic search results.

The systems and methods disclosed herein can leverage AI generation models to generate images that can be reviewed and selected to be utilized as a search query. In particular, the images can provide a more detailed context of what a user is requesting during the search, which can allow for a more tailored search than text alone.

Traditional searching for clothing, art, movies, and/or music can be difficult if a user does not have an example to provide to a search engine. Freeform text and/or Boolean strings provided as a text query to a search engine may provide mixed and/or unaligned search results that may be off topic and/or may include only parts of the search query. Refining those searches and/or reviewing those search results can be time intensive and may be non-intuitive. Image queries may provide more tailored results as images may include features that cannot be descriptively described via text in brevity. However, a user may not have access to an image of what they are looking for during the search, and/or the user may be basing their search on a real world example that they know of based on real world experience (e.g., a user may searching for a real world example of what they imagined).

In addition, the utilization of artificial intelligence techniques to generate images and/or other datasets can be non-intuitive, may be open-ended, and may be time consuming. Image generation systems such as DALLE (“DALL-E 2,” OPENAI (Apr. 6, 2022), https://openai.com/dall-e-2/.) utilize a prompt input box for receiving freeform text to be processed to generate one or more images. However, as a user utilizes the prompt input box, the user may struggle with which words to utilize and/or may be dissatisfied with the generated image as one or more of the input words may not be utilized in the direction the user desired (e.g., “fisheye” may be entered by the user in association with the image capture lens to be descriptive of a desired distortion; however, the model may generate an image with a fish).

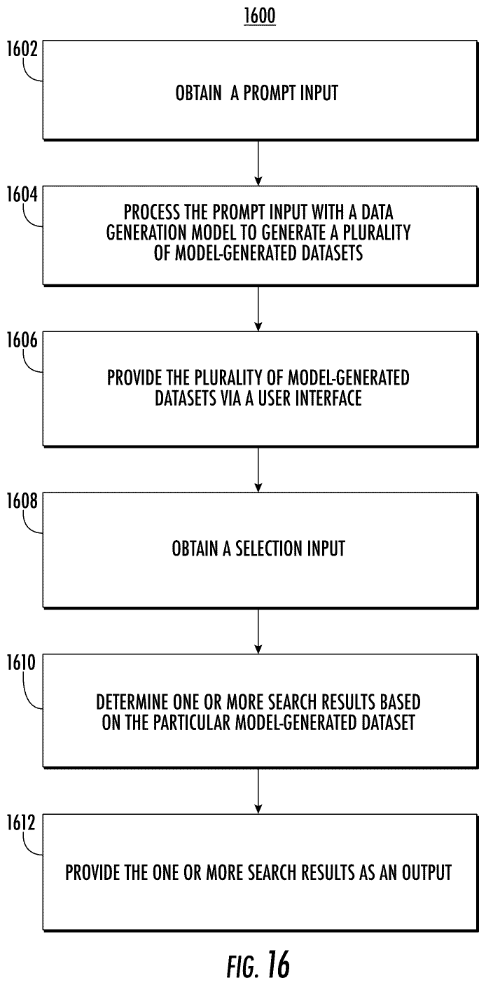

FIG. 16 depicts a flow chart diagram of an example method to perform according to example embodiments of the present disclosure. Although FIG. 16 depicts steps performed in a particular order for purposes of illustration and discussion, the methods of the present disclosure are not limited to the particularly illustrated order or arrangement. The various steps of the method 1600 can be omitted, rearranged, combined, and/or adapted in various ways without deviating from the scope of the present disclosure.

At 1602, a computing system can obtain a prompt input. The prompt input can include one or more terms. The prompt input can be generated based on one or more selections of one or more user interface chips that can include text characters and/or icons associated with terms to utilize to prompt a data generation model. In some implementations, the prompt input can include one or more images, one or more audio clips, and/or latent encoding data.

At 1604, the computing system can process the prompt input with a data generation model to generate a plurality of model-generated datasets. The plurality of model-generated datasets can be generated based at least in part on the one or more terms. In some implementations, each of the plurality of model-generated datasets may differ. The data generation model can be trained to generate one or more datasets based on a plurality of learned parameters and conditioned based on the prompt input. The model-generated dataset can include image data, audio data, multimodal data, text data, latent encoding data, and/or sensor data. For example, the plurality of model-generated datasets can include a plurality of images (e.g., a plurality of predicted depictions descriptive of the prompt input), a plurality of audio clips (e.g., a plurality of generated song clips predicted to be descriptive of the prompt input), and/or a plurality of video datasets (e.g., a plurality of predicted video clips generated based on the prompt input).

At 1606, the computing system can provide the plurality of model-generated datasets via a user interface. Providing the plurality of model-generated datasets via the user interface can include providing a plurality of model-generated images in an image carousel. The plurality of model-generated datasets can be provided as a list of links to preview the model-generated datasets. Alternatively and/or additionally, the plurality of model-generated datasets can be transmitted for local download.

At 1608, the computing system can obtain a selection input. The selection input can be descriptive of a selection of a particular model-generated dataset of the plurality of model-generated datasets. For example, the user may navigate through a carousel of model-generated datasets, can determine a specific model-generated dataset of interest, and the user can then select the specific model-generated dataset to be utilized to query a database.

In some implementations, obtaining the selection input can include obtaining the selection of the particular model-generated dataset of the plurality of model-generated datasets and obtaining a cropping input. The cropping input can be descriptive of a portion of the particular model-generated dataset. The portion of the particular model-generated dataset can be segmented to generate a cropped model-generated dataset. In some implementations, the one or more search results can be determined based on the cropped model-generated dataset.

At 1610, the computing system can determine one or more search results based on the particular model-generated dataset. The one or more search results can be determined based on an association with a resource dataset that is determined to be similar to the selected model-generated dataset. For example, a resource dataset can be a song determined to be similar to the model-generated audio clip.

At 1612, the computing system can provide the one or more search results as an output. The one or more search results can be provided in a search results page. In some implementations, the one or more search results can be provided adjacent to one or more model-generated datasets. For example, the one or more search results can be provided in a panel of the user interface, and the one or more model-generated datasets can be provided in a same panel and/or a different panel.

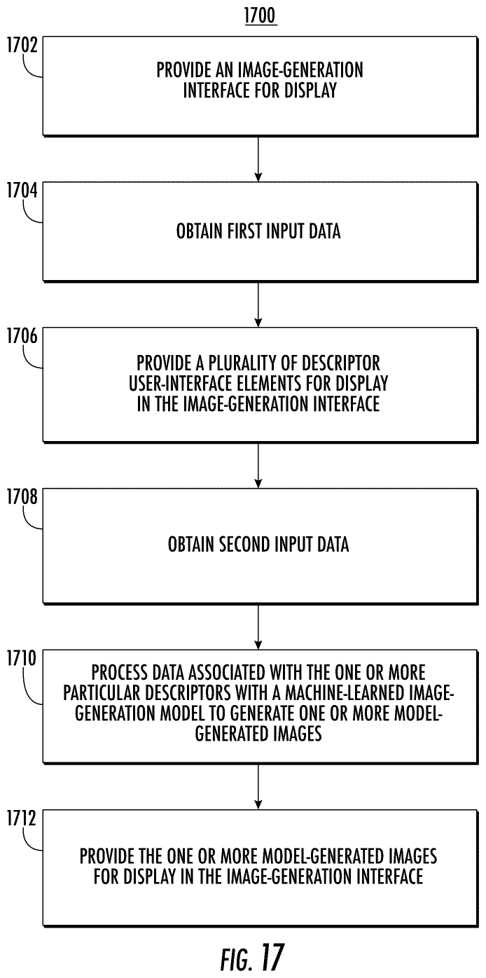

FIG. 17 depicts a flow chart diagram of an example method to perform according to example embodiments of the present disclosure. Although FIG. 17 depicts steps performed in a particular order for purposes of illustration and discussion, the methods of the present disclosure are not limited to the particularly illustrated order or arrangement. The various steps of the method 1700 can be omitted, rearranged, combined, and/or adapted in various ways without deviating from the scope of the present disclosure.

At 1702, a computing system can provide an image-generation interface for display. The image-generation interface can include a plurality of category user-interface elements. In some implementations, each category user-interface element (e.g., a chip, tile, and/or a drop-down element) can be associated with a different generation category (e.g., a scene, a mural, an article of clothing, and/or a video game).

At 1704, the computing system can obtain first input data. The first input data can be associated with a selection of a particular category user-interface element of the plurality of category user-interface elements. The particular category user-interface element can be associated with a particular category. In some implementations, the particular category can be associated with clothing. Additionally and/or alternatively, the one or more particular descriptors can be associated with one or more clothing terms descriptive of a clothing item.

At 1706, the computing system can provide a plurality of descriptor user-interface elements for display in the image-generation interface. Each descriptor user-interface element can be associated with a different descriptor (e.g., an adjective and/or a complementary noun or verb associated with the particular category). The descriptors may be general descriptors for a plurality of different categories. Alternatively and/or additionally the plurality of descriptors may be determined and/or provided based on the selected category (e.g., a clothing material and/or a brand may be provided based on a clothing category being selected).

At 1708, the computing system can obtain second input data. The second input data can be associated with a selection of one or more particular descriptor user-interface elements of the plurality of descriptor user-interface elements. The one or more particular descriptor user-interface elements can be associated with one or more particular descriptors. Additionally and/or alternatively, a freeform text input can be obtained. For example, a text input box may be provided for display and can be utilized to receive freeform text associated with one or more additional descriptors.

At 1710, the computing system can process data associated with the one or more particular descriptors with a machine-learned image-generation model to generate one or more model-generated images. In some implementations, a prompt can be generated based on the category selection and the descriptor selection(s). Additionally and/or alternatively, a specific machine-learned image-generation model can be obtained based on the selected category. The prompt may be a structured prompt based on a selection hierarchy (e.g., a category the descriptors and/or based on the time of selection).

At 1712, the computing system can provide the one or more model-generated images for display in the image-generation interface. The one or more model-generated images can be provided in a carousel interface, in a list, in a grid, and/or a slideshow interface.

In some implementations, the computing system can obtain third input data. The third input data can be descriptive of a selection of the one or more model-generated images. The systems and methods can then determine one or more search results based on the one or more model-generated images. The one or more search results can be associated with one or more objects. A search results interface can then be provided for display. The search results interface can provide the one or more search results for display.

Additionally and/or alternatively, edit input data can be obtained. The edit input data can be descriptive of a request to replace one or more first features of the one or more model-generated images with one or more second features. One or more updated model-generated images can then be generated based on the edit input data. The edit input data can be associated with a color change. In some implementations, the edit input data can be associated with a texture change.

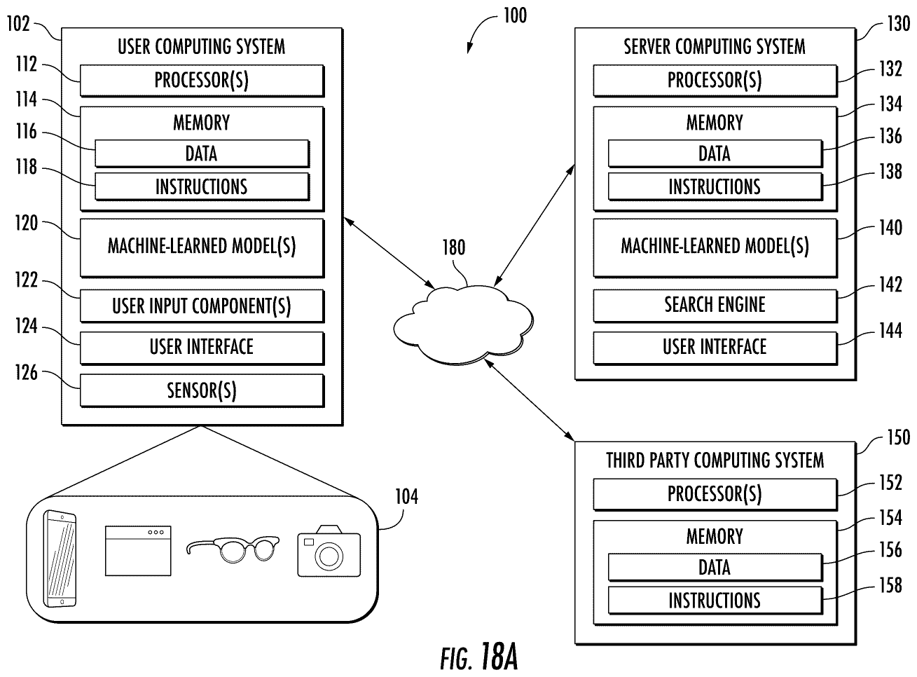

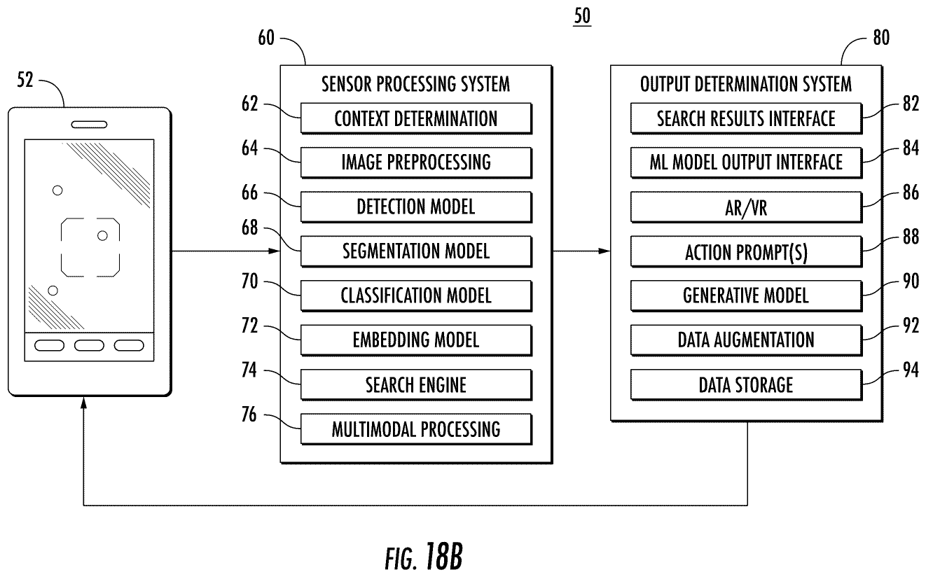

FIG. 18A depicts a block diagram of an example computing system 100 that performs machine-learned model output generation and search according to example embodiments of the present disclosure. The system 100 includes a user computing system 102, a server computing system 130, and/or a third party computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV:2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 102 can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 18B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 100 may utilize one or more soft prompts for conditioning the one or more machine-learned models (120 and/or 140) for downstream tasks. The one or more soft prompts can include a set of tunable parameters that can be trained (or tuned) as the parameters of the one or more machine-learned models (120 and/or 140) are fixed. The one or more soft prompts 124 can be trained for a specific task and/or a specific set of tasks. Alternatively and/or additionally, the one or more soft prompts 124 may be trained to condition the one or more machine-learned models (120 and/or 140) to perform inferences for a particular individual, one or more entities, and/or one or more tasks such that the output is tailored for that particular individual, particular entities, and/or particular task. The one or more soft prompts 124 can be obtained and processed with one or more inputs by the one or more machine-learned models (120 and/or 140).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 100 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 102 and/or the server computing system 130 may store one or more soft prompts associated with the particular user and/or particular task. The soft prompt(s) can include a set of parameters. The user computing system 102 and/or the server computing system 130 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 130 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.).

As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 120 and/or 140) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 18B depicts a block diagram of an example computing system 50 that performs machine-learned model output generation and search according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlayed over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 90 may be stored on-device and/or may be stored on a server computing system. In some implementations, the one or more generative models 90 can perform on-device processing to determine suggested searches, suggested actions, and/or suggested prompts. The one or more generative models 90 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 90 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ______.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv:1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv:2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for location searching, the system comprising:
one or more processors; and
one or more non-transitory computer-readable media that collectively store instructions that, when executed by the one or more processors, cause the computing system to perform operations, the operations comprising:
obtaining a search query, wherein the search query comprises a plurality of search terms, wherein the plurality of search terms comprise a plurality of different environment descriptors;
processing the search query with an image generation model to generate one or more model-generated images, wherein the one or more model-generated images comprise a plurality of predicted pixels descriptive of a predicted rendering of a model-generated environment comprising each of the plurality of different environment descriptors, wherein the image generation model comprises a generative model trained for text-to-image generation;
processing the one or more model-generated images with a search engine to determine one or more location search results based on image features of the one or more model-generated images, wherein the one or more location search results are associated with one or more model-generated environment features depicted in the one or more model-generated images; and
providing the one or more location search results for display with geographic information for the one or more location search results.

2. The system of claim 1, wherein the one or more model-generated images comprise one or more three-hundred and sixty degree renderings of the model-generated environment comprising each of the plurality of different environment descriptors.

3. The system of claim 2, wherein the operations further comprise:
providing an interactive user interface for providing an interactive window for viewing different portions of the one or more three-hundred and sixty degree renderings of the model-generated environment comprising each of the plurality of different environment descriptors.

4. The system of claim 2, wherein processing the one or more model-generated images with the search engine to determine the one or more location search results based on the image features of the one or more model-generated images comprises:
determining a sub-portion of the one or more three-hundred and sixty degree renderings of the model-generated environment is being viewed when a search invoking element is selected;
segmenting the sub-portion of the one or more three-hundred and sixty degree renderings of the model-generated environment; and
providing the sub-portion of the one or more three-hundred and sixty degree renderings of the model-generated environment to the search engine to determine the one or more location search results.

5. The system of claim 1, wherein processing the search query with the image generation model to generate the one or more model-generated images comprises:
generating a plurality of different candidate model-generated images based on processing the search query with the image generation model;
evaluating the plurality of different candidate model-generated images to generate a plurality of respective image scores; and
determining the one or more model-generated images of the plurality of different candidate model-generated images to provide to the search engine based on the plurality of respective image scores.

6. The system of claim 5, wherein the plurality of respective image scores are determined based on:
processing each of the plurality of different candidate model-generated images with one or more classification models to determine whether a respective candidate model-generated image comprises each of the plurality of different environment descriptors.

7. The system of claim 5, wherein the plurality of respective image scores are determined based on:
evaluating each of the plurality of different candidate model-generated images on one or more benchmarks for realism and hallucinations.

8. The system of claim 1, wherein processing the search query with the image generation model to generate the one or more model-generated images comprises:
generating a plurality of different initial model-generated images based on processing the search query with the image generation model; and
mosaicking the plurality of different initial model-generated images to generate the one or more model-generated images.

9. The system of claim 1, wherein the operations further comprise:
obtaining a task graph associated with a particular user that provided the search query, wherein the task graph comprises a learned embedding representation associated with learned interests of the user; and
wherein processing the search query with the image generation model to generate the one or more model-generated images comprises:
processing the search query and the task graph with the image generation model to generate the one or more model-generated images.

10. The system of claim 9, wherein the task graph was learned based on learning edges and nodes associated with the learned embedding representation by:
embedding search history instances of the particular user to generate a plurality of nodes; and
determining a plurality of edges by determining interlinking groupings between the plurality of nodes.

11. A computer-implemented method for searching with synthetic images, the method comprising:
obtaining, by a computing system comprising one or more processors, a prompt input, wherein the prompt input comprises a plurality of terms, wherein the plurality of terms comprise a description of a plurality of different environmental characteristics;
processing, by the computing system, the prompt input with an image generation model to generate one or more model-generated images, wherein the one or more model-generated images are generated based at least in part on the plurality of terms, wherein the image generation model was trained to process text data to generate one or more images comprising predicted pixels associated with features described with the text data, wherein the text data is descriptive of a plurality of different environment features;
determining, by the computing system, one or more location search results based on the one or more model-generated images, wherein the one or more location search results are associated with one or more model-generated environment features depicted in the one or more model-generated images; and
providing, by the computing system, a search results interface, wherein the search results interface provides the one or more location search results for display with geographic information for the one or more location search results.

12. The method of claim 11, wherein the plurality of terms describe a particular type of terrain and a particular type of plant, and wherein the one or more model-generated images depict a rendering of the particular type of plant within the particular type of terrain.

13. The method of claim 11, wherein the plurality of terms describe a particular type of architecture and a particular type of climate, and wherein the one or more model-generated images depict a rendering of the particular type of architecture within the particular type of climate.

14. The method of claim 11, wherein the plurality of terms describe a first attraction type and a second attraction type, and wherein the one or more model-generated images depict a rendering of a model-generated environment that comprises the first attraction type and the second attraction type.

15. The method of claim 11, further comprising:
obtaining, by the computing system, location data associated with a user location;
determining, by the computing system, one or more travel options for traveling from the user location to one or more destination locations associated with the one or more location search results; and
providing, by the computing system, the one or more travel options for display.

16. The method of claim 11, further comprising:
for each of the one or more location search results:
determining, by the computing system, a plurality of attractions associated with a respective location associated with a respective location search result;
generating a respective itinerary for the respective location search result, wherein the respective itinerary comprises a schedule for attending at least a subset of the plurality of attractions; and
providing the respective itinerary for display within the search results interface.

17. One or more non-transitory computer-readable media that collectively store instructions that, when executed by one or more computing devices, cause the one or more computing devices to perform operations, the operations comprising:
obtaining a prompt input from a user computing device, wherein the prompt input comprises a plurality of terms, wherein the plurality of terms comprise a description of a plurality of different food items;
determining a user location of a particular user associated with the user computing device;
processing the prompt input with an image generation model to generate one or more model-generated images, wherein the one or more model-generated images are generated based at least in part on the plurality of terms, wherein the image generation model was trained to process text data to generate one or more images comprising predicted pixels associated with food characteristics described with the text data, wherein the text data is descriptive of a plurality of different features;
processing the one or more model-generated images and the user location with a search engine to determine one or more restaurant search results, wherein the one or more restaurant search results are associated with a plurality of model-generated food items depicted in the one or more model-generated images, and wherein the one or more restaurant search results are within a threshold distance from the user location; and
providing a search results interface, wherein the search results interface provides the one or more search results for display with geographic information for the one or more search results.

18. The one or more non-transitory computer-readable media of claim 17, wherein the plurality of terms further comprise an aesthetic description, and wherein the one or more model-generated images comprise a rendering of the plurality of model-generated food items within a model-generated environment that comprises the aesthetic description.

19. The one or more non-transitory computer-readable media of claim 17, wherein the one or more model-generated images depict a first food item of a first food type and a second food item of a second food type.

20. The one or more non-transitory computer-readable media of claim 17, wherein the one or more model-generated images comprise a rendering of a model-generated menu that comprises the plurality of model-generated food items.
